(19) United States
(12) Patent Application Publication
(10) Pub. No.: US 2007/0012818 A1
(43) Pub. Date: Jan. 18, 2007

(54) Miniature aircraft

(75) Inventors: Osamu Miyazawa, Shimosuwa-machi (JP); Tsuyoshi Iwamoto, Shizuoka-shi (JP)

Correspondence Address: GLOBAL IP COUNSELORS, LLP, 1233 20TH STREET, NW, SUITE 700, WASHINGTON, DC, 20036-2680, US

(73) Assignee: Seiko Epson Corporation, Shinjuku-ku (JP)

(21) Appl. No.: 11/202,213

(22) Filed: Aug. 12, 2005

(30) Foreign Application Priority Data
Aug. 12, 2004 (JP) JP2004-235588

(51) Int. Cl. B64C 27/52

(52) U.S. Cl. 244/17.25

(57) ABSTRACT

A miniature aircraft 1 has a center axle 22, two rotors 3 and 5 provided substantially axially to the center axle 22 and capable of rotating in opposite directions, rotary wings 34 and 54 provided to the rotors 3 and 5, vibrating members 4 for rotating the rotary wings 34 and 54 via the rotors 3 and 5, and cables 471 and 472 connected to the vibrating members 4. A hollow part 221 is formed in the center axle 22 along the longitudinal direction thereof, and the cables 471 and 472 are easily positioned in the hollow part 221.

### FIELD OF INDUSTRIAL UTILIZATION

The present invention relates to a miniature aircraft.

### PRIOR ART

Helicopters and the like are known examples of aircrafts (flying objects) that can soar in the air by using rotating rotors (rotor heads) having rotary wings, and miniature aircraft can be cited as examples of toys (toy helicopters) and the like (for example, see Prior Art 1). However, with miniature aircraft it is sometimes difficult to place (lay) the cable (for example, the cable of the motor (drive source) for rotating the rotary wings) near the axle that is the rotational center of the rotary wings. Also, there is the danger that the cable will wind around the axle when the rotary wings (axle) rotate.

[Prior Art 1] Japanese Laid-Open Patent Application No. 2004-121798

### SUMMARY OF THE INVENTION

[Problems which the Invention is Intended to Solve]

An object of the present invention is to provide a miniature aircraft wherein the cable connected to the drive source can be easily positioned.

[Means Used to Solve the Above-Mentioned Problems]

Such an object is achieved by the present invention as follows.

The miniature aircraft of the present invention has an axle;

two rotors which are capable of rotating in opposite directions and are disposed substantially coaxially with the axle;

rotary wings provided to the rotors;

a drive source for rotating the rotary wings via the rotors; and

a cable connected to the drive source; wherein

a hollow section is formed in the axle along the longitudinal direction thereof, and the cable is inserted through the hollow section.

The cable connected to the drive source can thereby be easily positioned.

The miniature aircraft of the present invention preferably includes a cowling that has a vertically upward oriented convexity and a symmetrical shape as seen from the longitudinal direction of the axle in the reference orientation.

The airborne orientation (airborne state) of the miniature aircraft can thereby be stabilized.

The miniature aircraft of the present invention preferably has a cowling which is provided to the axle and has a vertically upward oriented convexity in the reference orientation; and

a fuel cell as an area for storing energy to drive the miniature aircraft; wherein

at least part of the cowling constitutes part of the fuel cell.

The number of components constituting the fuel cell can thereby be reduced.

The miniature aircraft of the present invention preferably has a cowling which is provided to the axle and has a vertically upward oriented convexity in the reference orientation; and

a fuel cell for storing energy to drive the miniature aircraft; wherein

at least part of the cowling functions as a casing for the fuel cell.

Thereby, a separate casing for the fuel cell does not need to be provided.

In the miniature aircraft of the present invention, it is preferable that the cowling has a cavity that opens vertically upward in the reference orientation.

The size (height) of the miniature aircraft can thereby be reduced (suppressed).

In the miniature aircraft of the present invention, the cowling is preferably configured from metal material, resin material, or a combination thereof.

The cowling can thereby be easily formed.

The miniature aircraft of the present invention preferably has a circuit board having specific circuits; a thrust generation device composed of the rotors, rotary wings, and drive source on the main body having an energy storage device for storing energy to drive the miniature aircraft; a displacement mechanism for displacing the thrust generation device; and an orientation varying device (orientation changer) for varying the airborne orientation with the displaced thrust generation device.

The miniature aircraft can thereby be flown in a stable manner.

The miniature aircraft of the present invention preferably has the rotors, the displacement mechanism, the circuit board, and the energy storage device in sequence vertically downward in the reference orientation.

The center of gravity of the miniature aircraft can thereby be lowered, and the miniature aircraft can be flown in a more stable manner.

In the miniature aircraft of the present invention, it is preferable that the energy storage device is configured from a battery; and

the aircraft has a plurality of pawls for engaging with the edge of the battery and holding the battery in a detachable manner.

The battery can thereby be easily replaced.

The miniature aircraft of the present invention preferably has a grounding device which supports the miniature aircraft and has a fixed unit with a gimbal structure that is fixed in place on the axle further vertically upward than the displacement mechanism, and also has a leg extending vertically downward from the fixed unit; wherein

the aircraft is configured so that the axle is oriented substantially vertically upward by the gimbal structure when the aircraft is grounded by the grounding device.

The miniature aircraft thereby takes off more easily because the thrust during takeoff is oriented vertically upward.

In the miniature aircraft of the present invention, it is preferable that the energy storage device is configured from a storage battery;

electrodes connected to a power supply source are provided to the grounding locations at which the miniature aircraft is grounded; and

when the aircraft is grounded at the two grounding locations by the grounding device, the storage battery conducts electric current to the electrodes via the leg, and power from the power supply source is stored.

Power can thereby be reliably stored in the storage battery every time the miniature aircraft is grounded at the grounding locations.

In the miniature aircraft of the present invention, it is preferable that the rotary wings and the displacement mechanism are provided so as to be symmetrical as seen from the longitudinal direction of the axle.

The airflow from the rotary wings can thereby be entirely made to flow vertically upward, whereby the stability of the airborne miniature aircraft in the vertical) direction can be improved.

The miniature aircraft of the present invention preferably has a circuit board having specific circuits; and

a holding frame which holds the circuit board and is shaped as a substantially rectangular prism; wherein

the circuit board is disposed along the outer periphery of the holding frame.

The surface area of the circuit board can thereby be increased, and many circuits can be formed on the circuit board.

The miniature aircraft of the present invention preferably has a circuit board having specific circuits; and

a holding frame which holds the circuit board and is shaped as a substantially rectangular prism; wherein

the circuit board is provided on the inner side of the holding frame.

The inner side of the holding frame can thereby be utilized efficiently.

### BRIEF DESCRIPTION OF THE DRAWINGS

FIG. 1 is a perspective view showing the first embodiment of the miniature aircraft of the present invention;

FIG. 2 is a cross-sectional side view showing an enlargement of the area near the center axis in the miniature aircraft shown in FIG. 1.

FIG. 3 is a perspective view showing the stabilizer bar in the miniature aircraft shown in FIG. 1 and the vicinity thereof;

FIG. 4 is a perspective view of a vibrating member in the miniature aircraft shown in FIG. 1;

FIG. 5 is a plan view showing the manner in which the vibrating member drives a driven member in the miniature aircraft shown in FIG. 1;

FIG. 6 is a plan view showing the manner in which the convexity of the vibrating member moves in an elliptical pattern in the miniature aircraft shown in FIG. 1;

FIG. 7 is a perspective view of the orientation varying device in the miniature aircraft shown in FIG. 1;

FIG. 8 is a perspective view of a linear actuator of the orientation varying device shown in FIG. 7;

FIG. 9 is a plan view of a linear actuator of the orientation varying device shown in FIG. 7;

FIG. 10 is a cross-sectional view along the line A-A in FIG. 9;

FIG. 11 is a plan view showing another structural example of the linear actuator;

FIG. 12 is a perspective view of a vibrating member in the miniature aircraft shown in FIG. 1;

FIG. 13 is a plan view showing the manner in which the vibrating member drives a driven member in the miniature aircraft shown in FIG. 1;

FIG. 14 is a plan view showing the manner in which the vibrating member drives a driven member in the miniature aircraft shown in FIG. 1;

FIG. 15 is a vie of a block diagram showing the circuit configuration in the miniature aircraft shown in FIG. 1;

FIG. 16 is a schematic view (side view) for describing the operation of the miniature aircraft shown in FIG. 1;

FIG. 17 is a schematic view (side view) for describing the operation of the miniature aircraft shown in FIG. 1;

FIG. 18 is a schematic view (side view) for describing the operation of the miniature aircraft shown in FIG. 1;

FIG. 19 is a schematic view (side view) for describing the operation of the miniature aircraft shown in FIG. 1;

FIG. 20 is a schematic view (plan view) for describing the operation of the miniature aircraft shown in FIG. 1;

FIG. 21 is a graph showing the relationship between the altitude of the miniature aircraft and the lift when the spring force (elastic force) of the legs of the grounding device of the miniature aircraft shown in FIG. 1 and the rotational frequency of the rotary wings (rotor) are constant;

FIG. 22 is a schematic view (side view) for describing the operation and the like of the miniature aircraft shown in FIG. 1;

FIG. 23 is a schematic view (side view) for describing the operation and the like of the miniature aircraft shown in FIG. 1;

FIG. 24 is a side view showing the second embodiment of the miniature aircraft of the present invention;

FIG. 25 is a perspective view showing the third embodiment of the miniature aircraft of the present invention; and

FIG. 26 is a side view of a condition in which the miniature aircraft shown in FIG. 25 is grounded.

### DESCRIPTION OF THE PREFERRED EMBODIMENTS

Embodiments of the invention will now be described with reference to the drawings. As will be apparent from the disclosure of the present invention to those skilled in the art, the description of the invention embodiments is intended solely to illustrate the present invention and should not be construed as limiting the scope of the present invention, which is defined by the claims described below or by equivalent claims thereof.

### First Embodiment

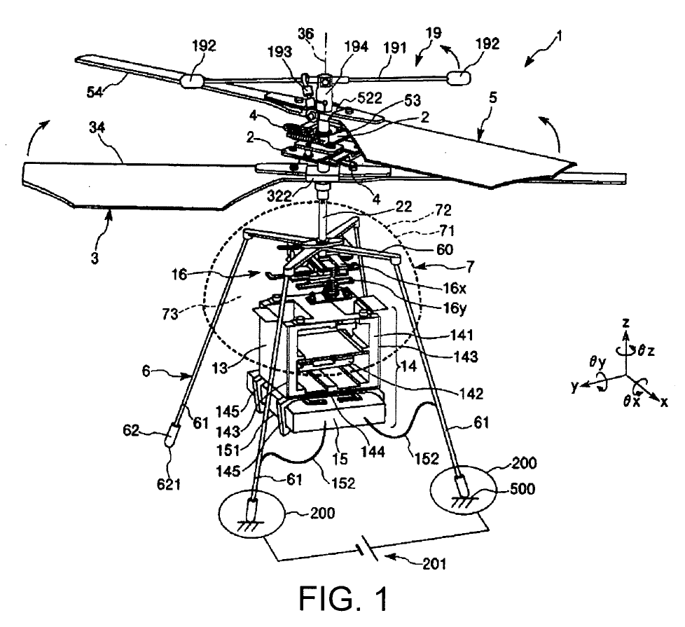

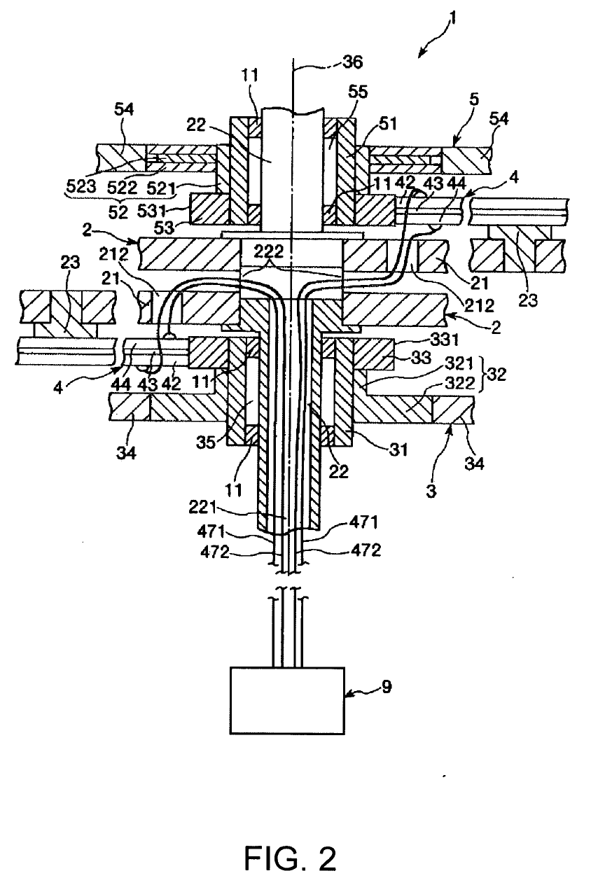

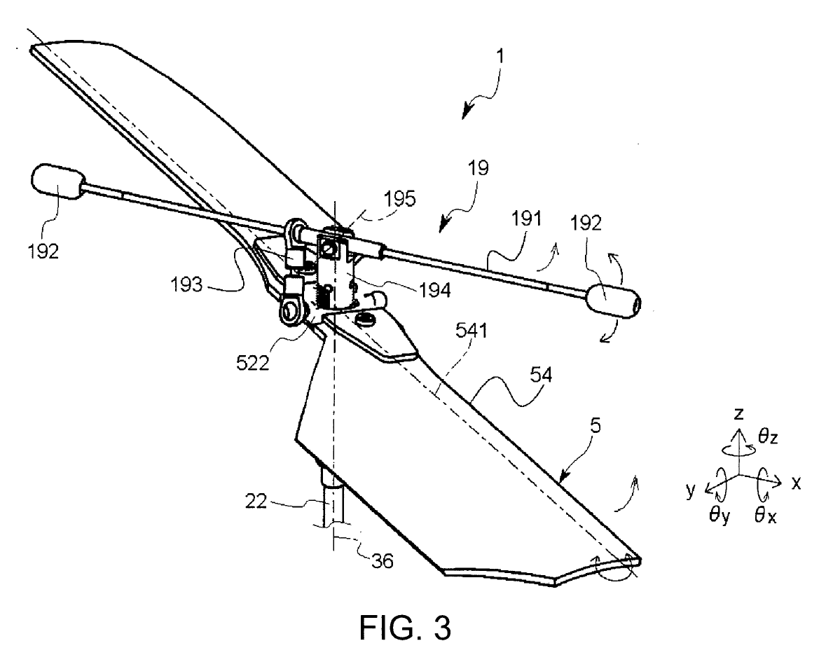

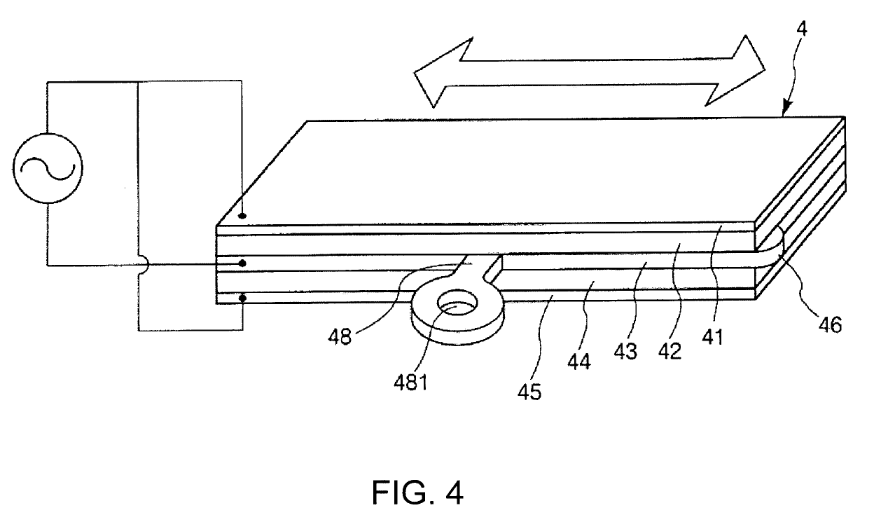

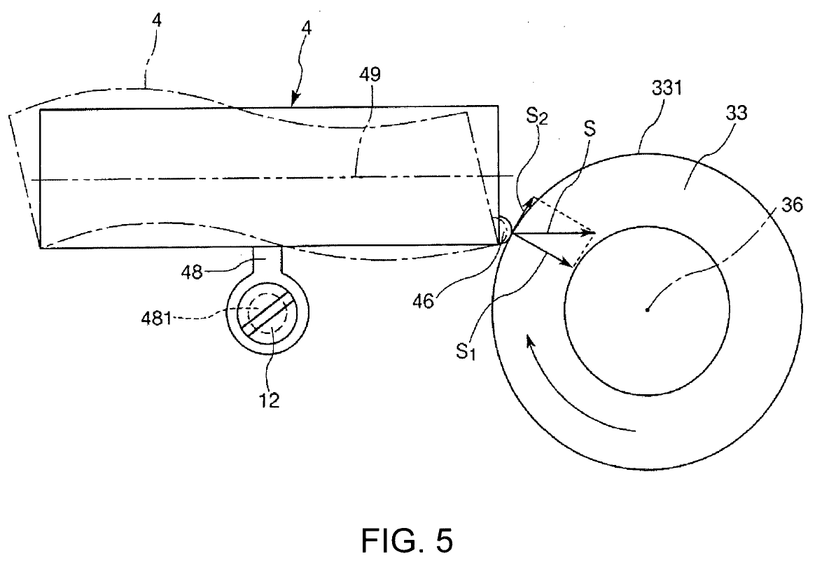

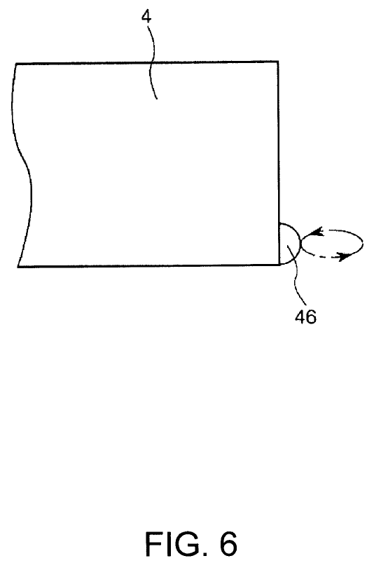

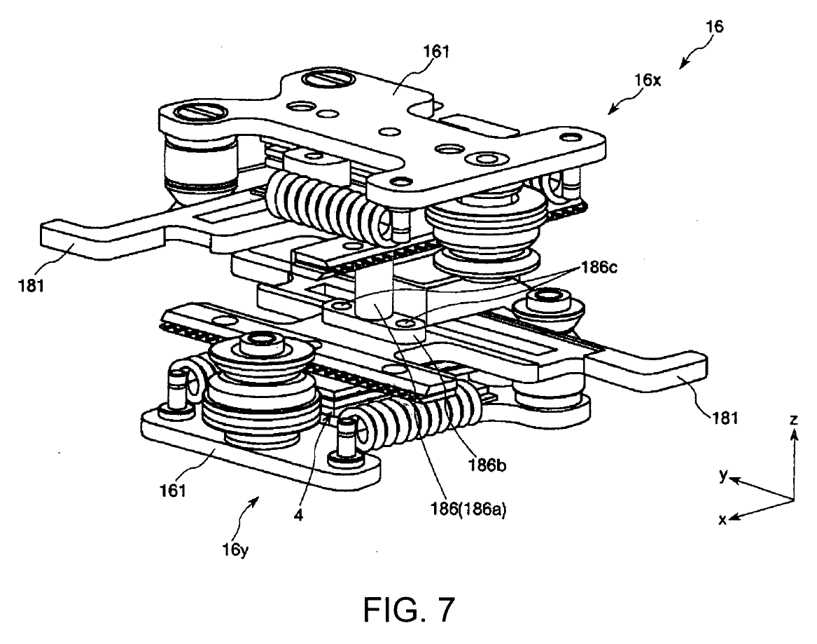

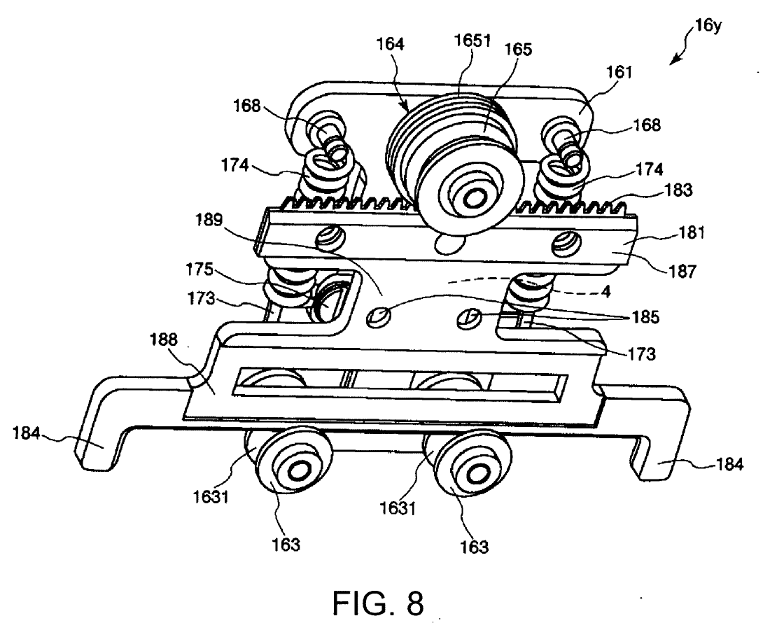

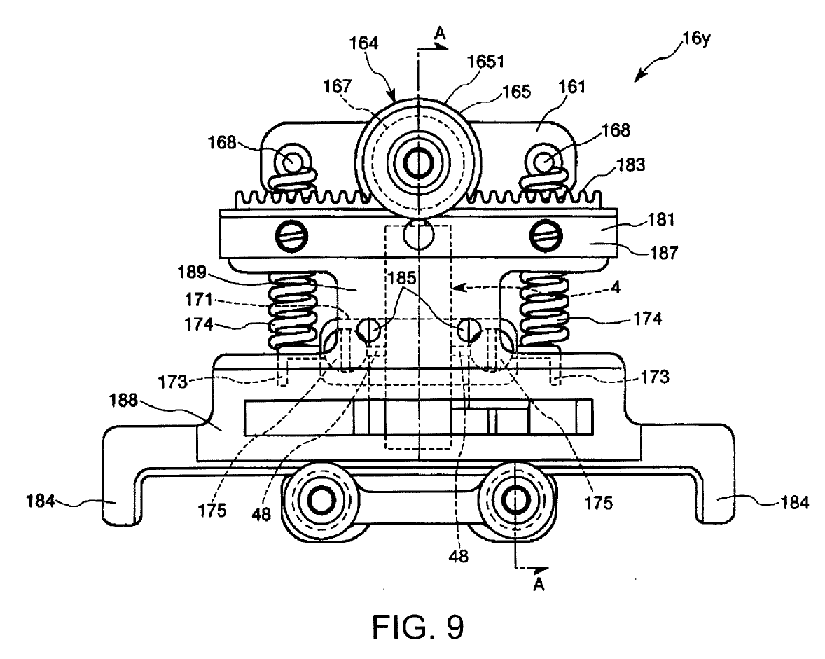

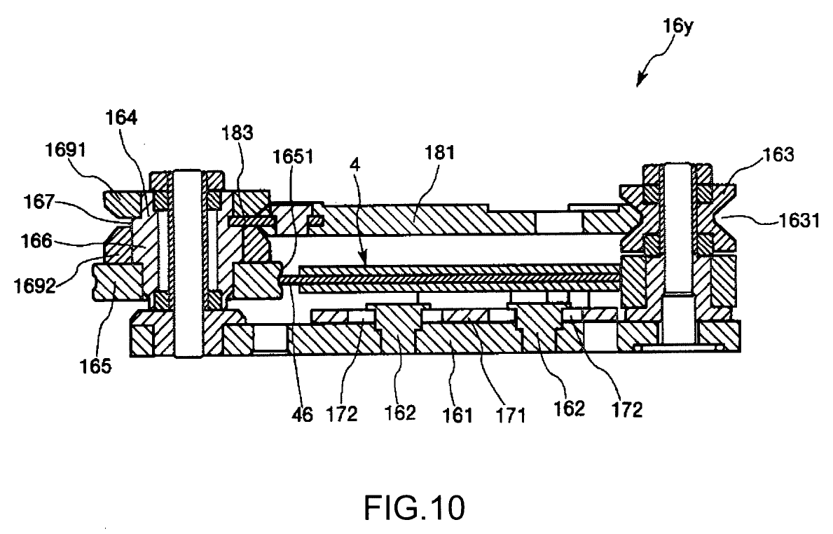

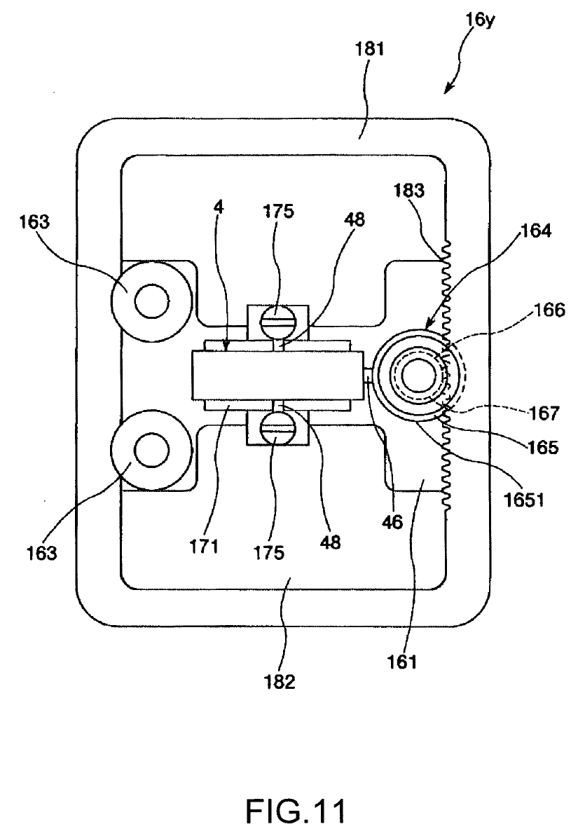

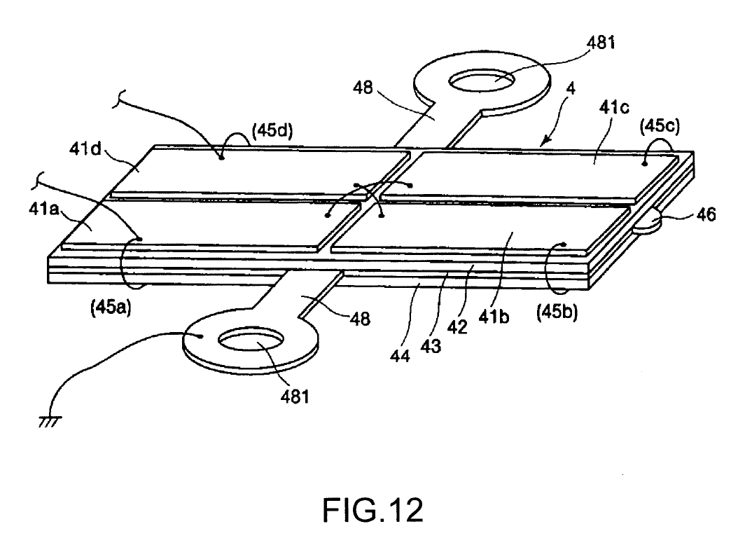

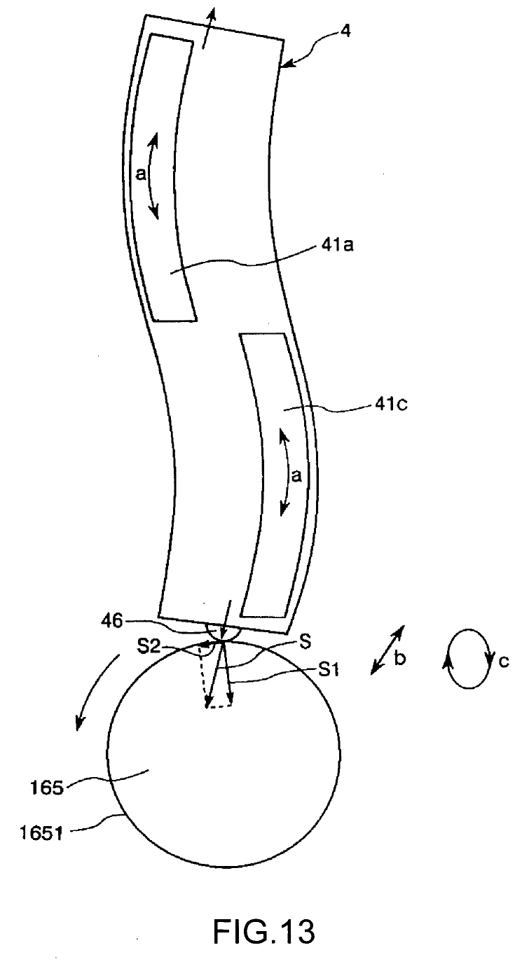

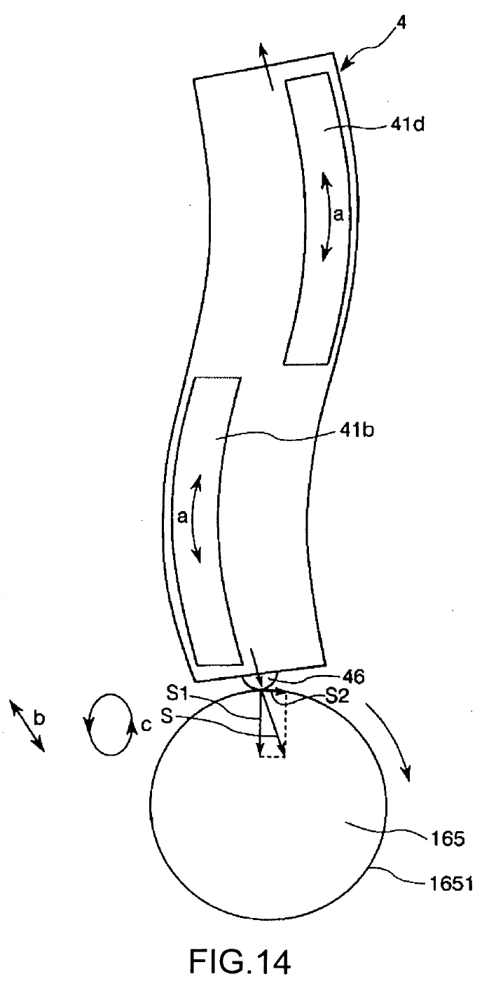

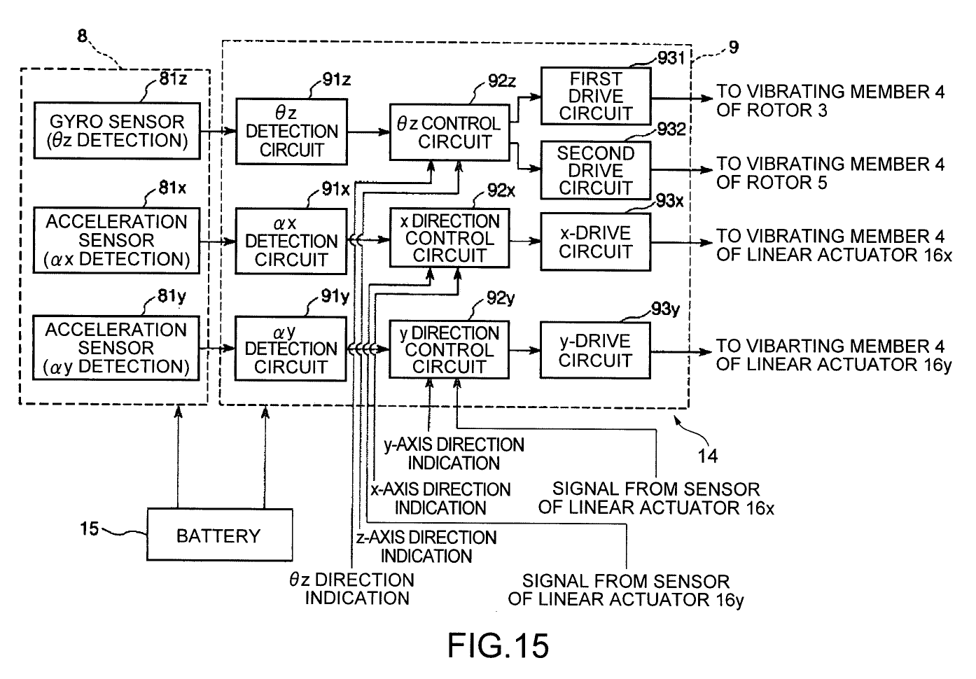

FIG. 1 is a perspective view showing the first embodiment of the miniature aircraft of the present invention, FIG. 2 is a cross-sectional side view showing an enlargement of the area near the center axle in the miniature aircraft shown in FIG. 1, FIG. 3 is a perspective view showing a stabilizer bar and the surrounding area in the miniature aircraft shown in FIG. 1, FIG. 4 is a perspective view of a vibrating member in the miniature aircraft shown in FIG. 1, FIG. 5 is a plan view showing the manner in which the vibrating member drives a driven member in the miniature aircraft shown in FIG. 1, FIG. 6 is a plan view showing the manner in which the convexity of the vibrating member moves in an elliptical pattern in the miniature aircraft shown in FIG. 1, FIG. 7 is a perspective view of the orientation varying device (orientation changer) in the miniature aircraft shown in FIG. 1, FIG. 8 is a perspective view of a linear actuator of the orientation varying device in the miniature aircraft shown in FIG. 1, FIG. 9 is a plan view of the linear actuator of the orientation varying device in the miniature aircraft shown in FIG. 1, FIG. 10 is a cross-sectional view along the line A-A in FIG. 9, FIG. 11 is a plan view showing another structural example of the linear actuator, FIG. 12 is a perspective view of the vibrating member in the miniature aircraft shown in FIG. 1, FIGS. 13 and 14 are plan views showing the manner in which the vibrating member drives the driven member in the miniature aircraft shown in FIG. 1, and FIG. 15 is a block view showing the circuit configuration in the miniature aircraft shown in FIG. 1.

In the following descriptions, the top (upper side) of FIGS. 1, 2, 3, and 7 is referred to as the “top,” and the bottom (lower side) is referred to as the “bottom.”

Also, the orientation of the miniature aircraft shown in FIG. 1 is referred to as the “reference orientation,” and in FIG. 1, the up/down direction is referred to as the “vertical direction,” the top (upper side) is referred to as the “vertical top (vertical upper side),” and the bottom (lower side) is referred to as the “vertical bottom (vertical lower side).”

Also, in FIGS. 1, 3, and 7, an x-axis, y-axis, and z-axis (x-y-z coordinates) that intersect with each other are assumed to have the arrangement shown in the diagrams. The z-axis is assumed in this case to coincide with or be parallel to the rotational centerline (rotational center axis) of the rotors.

The miniature aircraft 1 shown in these diagrams has a substantially pillar-shaped center axle (axle) 22, two base parts 2 fixed in place on the center axle 22 so as to face each other, a rotor (first rotor) 3 that is rotatably disposed on the center axle 22 (the lower base part 2) and that includes a rotary wing (first rotary wing) 34, a vibrating member (ultrasonic motor) 4 provided to the lower base part 2 as a drive source for rotatably driving the rotor 3 (rotary wing 34), a rotor (second rotor) 5 that is rotatably provided to the center axle 22 (upper base part 2) and that includes a rotary wing (second rotary wing) 54, a vibrating member (ultrasonic motor) 4 provided to the upper base part 2 as a drive source for rotatably driving the rotor 5, an orientation stabilizer (stabilizer) 19 for stabilizing the airborne orientation of the miniature aircraft 1, an orientation varying device (orientation changer) 16 for varying the airborne orientation of the miniature aircraft 1 by moving its center of gravity, a grounding device 6 that is fixed in place on the center axle 22 for supporting the miniature aircraft 1, and a cowling 7 that creates an airflow along the outer surface 71. The rotor 3 and the rotor 5 rotate in opposite directions and are disposed coaxially. Specifically, the miniature aircraft 1 includes two contrarotating rotors.

A thrust generation device (lift creating device) for creating thrust (lift) is primarily configured by the rotors 3 and 5, the vibrating member 4 for rotatably driving the rotor 3 (rotary wing 34), and the vibrating member 4 for rotatably driving the rotor 5 (rotary wing 54). In the reference orientation, the thrust generation device is disposed at the vertical top, and the orientation varying device 16 and grounding device 6 are both disposed at the vertical bottom.

The configuration of the components will now be described.

As shown in FIGS. 1 and 2, the two base parts 2 both have a base plate 21 with a substantial flat plate shape, and a vibrating member mounting unit 23 provided to the base plate 21. In the base part 2 on the upper side, the vibrating member mounting unit 23 is provided to the upper side of the base plate 21, and in the rotor 3 on the lower side, the vibrating member mounting unit 23 is provided to the lower side of the base plate 21.

The rotor 3 is rotatably disposed below the lower side base part 2 on the center axle 22.

The rotor 3 rotates clockwise as viewed in a plane (as seed from the upper side in FIG. 2).

As shown in FIG. 2, the rotor 3 has a cylindrical member 31 with a substantially cylindrical shape, a rotary wing fixing member 32 and driven member 33 that are both joined (fixed) to the outer side (outer periphery) of the cylindrical member 31, and two rotary wings (first rotary wing) 34 that are both joined to the rotary wing fixing member 32.

The rotor 3 is disposed so that the center axle 22 is inserted through the cavity of the cylindrical member 31, specifically, through an axle hole 35. Two bearings 11, 11 are provided between the center axle 22 and the inner surface of the axle hole 35, whereby the rotor 3 is enabled to rotate smoothly around the center axle 22 (rotational centerline 36) in relation to the base parts 2.

The bearings 11 are configured from sliding bearings, but ball-and-roller bearings may also be used.

The rotary wing fixing member 32 is configured from a cylindrical part 321 formed into a substantial cylinder, and a fixing part 322 formed to protrude from the lower end of the cylindrical part 321 in a direction substantially orthogonal to the rotational centerline 36 of the rotor 3. The rotary wing fixing member 32 is joined to the cylindrical member 31 by press fitting, for example, with the cylindrical member 31 inserted through the inner side of the cylindrical part 321.

The base parts (roots) of the two rotary wings 34 are both joined to the fixing part 322.

The two rotary wings 34 are provided so as to extend from the rotational centerline 36 in opposite directions from each other. Specifically, the two rotary wings 34 are provided at substantially 180° intervals. Also, the rotary wings 34 are disposed in an orientation substantially orthogonal to the rotational centerline 36.

The rotary wings 34 also rotate along with the clockwise rotation of the rotor 3 as seen in a plane (as seen from the upper side in FIG. 2) due to the driving of the vibrating member 4 to be described later. Specifically, the rotary wings 34 rotate via the rotor 3 due to the driving of the vibrating member 4. Lifting force (upward force substantially parallel to the rotational centerline 36) acts on the rotary wings 34.

The number of rotary wings 34 provided to the rotor 3 is not limited to two, and three or more rotary wings may also be provided.

The driven member 33 is provided to the outer periphery at the upper end of the cylindrical member 31. Specifically, the driven member 33 is disposed on the upper side of the rotary wing fixing member 32.

The driven member 33 has a substantial ring shape (annular shape), and is joined to the cylindrical member 31 by press fitting, for example, with the upper end of the cylindrical member 31 inserted through the inner side thereof.

The cylindrical member 31, the rotary wing fixing member 32, and the driven member 33 may be formed integrally (as one member). The rotary wings 34 may also be formed integrally with these members.

The vibrating member 4 for rotatably driving such a rotor 3 may be provided to the lower side of the base parts 2 so as to be in contact with the outer peripheral surface 331 of the driven member 33.

The rotor 5 is rotatably disposed above the upper side base part 2 on the center axle 22. The rotor 5 rotates counterclockwise as viewed in a plane (as seed from the upper side in FIG. 2).

The rotor 5 has a cylindrical member 51 with a substantially cylindrical shape, a rotary wing fixing member 52 and driven member 53 that are both joined (fixed) to the outer side (outer periphery) of the cylindrical member 51, and two rotary wings (second rotary wing) 54 that are both joined to the rotary wing fixing member 52, and is disposed above the rotor 3 coaxially (concentrically) with the rotor 3.

The rotor 5 is disposed so that the center axle 22 is inserted through the cavity of the cylindrical member 51, specifically, through an axle hole 55. Two bearings 11, 11 are provided between the center axle 22 and the inner surface of the axle hole 55, whereby the rotor 5 is enabled to rotate smoothly around the center axle 22 (rotational centerline 36) in relation to the base parts 2.

The rotary wing fixing member 52 is configured from a cylindrical part 521 formed into a substantial cylinder, two axles 523 formed to protrude from the upper end of the cylindrical part 521 in a direction substantially orthogonal to the rotational centerline 36 of the rotor 5, and a fixing part 522 disposed to be capable of rotating around the two axles 523 at a specific angle. The axles 523 protrude in opposite directions from each other. The rotary wing fixing member 52 is joined to the cylindrical member 51 by press fitting, for example, with the cylindrical member 51 inserted through the inner side of the cylindrical part 521.

The base parts (roots) of the two rotary wings 54 are both joined to the fixing part 522.

The two rotary wings 54 are disposed along the corresponding axles 523 (in a way in which the axles 523 coincide with or are parallel to an axis 541 substantially parallel to the longitudinal direction of the rotary wings 54) so as to extend from the rotational centerline 36 in opposite directions from each other. Specifically, the two rotary wings 54 are provided at substantially 180° intervals. Also, the rotary wings 54 are disposed in an orientation substantially orthogonal to the rotational centerline 36.

When the fixing part 522 rotates around the axles 523, the rotary wings 54 rotate with the fixing part 522 around the axle 541 substantially parallel to the longitudinal direction, and the pitch angle of the rotary wings 54 varies.

The pitch angle of the rotary wings 54 is preferably 1 to 6 degrees less than the pitch angle of the rotary wings 34, and is even more preferably 2 to 5 degrees less. Sufficient lift can thereby be obtained.

Also, when, for example, the rotational angle of the rotary wings 54 has increased, the vibrating member 4 must vibrate strongly because the resistance torque of the rotor 5 increases. However, the vibrating member 4 can be suppressed from vibrating strongly, specifically, it is possible to prevent a load from being applied to the vibrating member 4, by decreasing the pitch angle of the rotary wings 54 to less than the pitch angle of the rotary wings 34.

The rotary wings 54 similarly rotate along with the counterclockwise rotation of the rotor 5 as seen in a plane (as seen from the upper side in FIG. 2) as a result of the driving of the vibrating member 4, to be described later. Specifically, the rotary wings 54 rotate via the rotor 3 due to the driving of the vibrating member 4. Lifting force (upward force substantially parallel to the rotational centerline 36) acts on the rotary wings 54.

The number of rotary wings 54 provided to the rotor 5 is not limited to two, and three or more rotary wings may also be provided.

The driven member 53 is provided to the outer periphery at the lower end of the cylindrical member 51. Specifically, the driven member 53 is disposed on the lower side of the rotary wing fixing member 52.

The driven member 53 has a substantial ring shape (annular shape), and is joined to the cylindrical member 51 by press fitting, for example, with the lower end of the cylindrical member 51 inserted through the inner side thereof.

The cylindrical member 51, the cylindrical part 521 of the rotary wing fixing member 52, the axles 523, and the driven member 53 may be formed integrally (as one member). The rotary wings 54 may also be formed integrally with the fixing part 522.

According to such a configuration, the rotary wings 54 are disposed farther up than the rotary wings 34. Also, the rotary wings 54 are disposed on the upper side of the base plate 21 of the upper side base part 2, and the rotary wings 34 are disposed on the lower side of the base plate 21 of the lower side base part 2.

When the rotor 3 rotates clockwise as seen in a plane (as seen from the upper side in FIG. 2), lift acts on the rotary wings 34, and when the rotor 5 rotates in the opposite direction from the rotor 3, lift acts on the rotary wings 54, and the miniature aircraft 1 rises into the air (flies) as a result of this lift.

Next, a vibrating member 4 for rotatably driving the rotor 3 will be described as a typical example of the vibrating member 4.

The vibrating member 4 has a substantially rectangular shape, as shown in FIG. 4. The vibrating member 4 is configured by stacking, in sequence as seen from the upper side of in FIG. 4, a plate-shaped electrode 41, a plate-shaped piezoelectric element 42, a reinforcing plate 43, a plate-shaped piezoelectric element 44, and a plate-shaped electrode 45. The thickness direction is depicted in an exaggerated manner in FIG. 4.

The piezoelectric elements 42 and 44 have a rectangular shape, and they elongate or constrict in the longitudinal direction as a result of voltage being applied. The structural material of the piezoelectric elements 42 and 44 is not particularly limited, and may be, for example, lead zirconate titanate (PZT), crystal, lithium niobate, barium titanate, lead titanate, lead metaniobate, polyvinylidene fluoride, zinc lead niobate, scandium lead niobate, or various other materials.

These piezoelectric elements 42 and 44 are joined to either side of the reinforcing plate 43. The reinforcing plate 43 has a function for reinforcing the entire vibrating member 4, and it prevents the vibrating member 4 from being damaged by excessive amplitude, external forces, or the like. The structural material of the reinforcing plate 43 is not particularly limited as long as it is elastic (elastically deformable), but is preferably, for example, stainless steel, aluminum or an aluminum alloy, titanium or a titanium alloy, copper or a copper alloy, or other such various metal materials.

The reinforcing plate 43 is preferably less in thickness (thinner) than the piezoelectric elements 42 and 44. The vibrating member 4 can thereby be highly efficiently vibrated.

The reinforcing plate 43 has a function as a common electrode for the piezoelectric elements 42 and 44. Specifically, AC voltage is applied to the piezoelectric element 42 by the electrode 41 and the reinforcing plate 43, and AC voltage is applied to the piezoelectric element 44 by the electrode 45 and the reinforcing plate 43. Specifically, as shown in FIG. 2, the vibrating member 4 is connected to a drive control circuit 9 to be described later, and AC voltage is applied by means of the drive control circuit 9 as a result.

The piezoelectric elements 42 and 44 elongate repeatedly in the longitudinal direction when AC voltage is applied; accordingly, the reinforcing plate 43 also elongates repeatedly in the longitudinal direction. Specifically, when AC voltage is applied to the piezoelectric elements 42 and 44, the vibrating member 4 vibrates (longitudinal vibration) minutely in the longitudinal direction as shown by the arrow in FIG. 4, and a convexity 46 vibrates longitudinally (two-way movement).

The convexity (contact part) 46 is formed integrally with the right end of the reinforcing plate 43 in FIG. 4. This convexity 46 is provided at a location displaced from the widthwise center (centerline 49) of the reinforcing plate 43 (the corner in the depicted configuration). The convexity 46 is formed so as to protrude in the shape of a substantial half circle in the depicted configuration.

An arm 48 having elasticity (flexibility) is formed integrally on the reinforcing plate 43. The arm 48 is provided so as to protrude in a direction substantially orthogonal to the longitudinal direction from the substantial longitudinal center of the reinforcing plate 43. A hole 481 through which a bolt 12 is inserted is formed in the arm 48.

Such a vibrating member 4 is disposed so as to come into contact with (touch) the outer peripheral surface 331 of the driven member 33 at the convexity 46, as shown in FIGS. 2 and 5. Specifically, in the present embodiment, the vibrating member 4 is disposed to come into contact with the driven member 33 from the radial outer peripheral side of the driven member 33.

The outer peripheral surface 331 is smooth in the depicted configuration, but a cross groove may be formed in the entire periphery, and the convexity 46 may come into contact with the inside of this groove.

As shown in FIGS. 2 and 5, a screw hole is formed in the vibrating member mounting unit 23 that protrudes downward from the base plate 21 of the lower side base part 2, and the vibrating member 4 is fixed in place to the vibrating member mounting unit 23 by the bolt 12 inserted through the hole 481 of the arm 48.

The vibrating member 4 is thus supported by the arm 48. The vibrating member 4 can thereby vibrate freely, and vibrates at comparatively large amplitude. Also, the vibrating member 4 is disposed in a state in which the convexity 46 is pressed against the outer peripheral surface 331 due to the elasticity of the arm 48.

Also, the vibrating member 4 is disposed in an orientation substantially orthogonal to the rotational centerline 36 (an orientation substantially parallel to the rotary wings 34). The space occupied by the vibrating member 4 thereby decreases vertically.

When AC voltage is applied to the piezoelectric elements 42 and 44 to vibrate the vibrating member 4 in a state in which the convexity 46 is pressed against the outer peripheral surface 331 of the driven member 33, the driven member 33 receives the frictional force (press force) from the convexity 46 when the vibrating member 4 elongates.

Specifically, as shown in FIG. 5, a large frictional force is applied between the convexity 46 and the outer peripheral surface 331 by the diametral component S1 of vibration displacement S of the convexity 46 (displacement of the driven member 33 in the diametral direction), and the clockwise rotational force in FIG. 5 is applied to the driven member 33 by the peripheral component S2 of vibration displacement S (displacement of the driven member 33 in the circumferential direction).

When the vibrating member 4 vibrates, this force repeatedly acts on the driven member 33, and the driven member 33 rotates clockwise in FIG. 5. The rotor 3 thereby rotates clockwise in FIG. 5 (as seen from the lower side in FIG. 2).

The vibrating member 4 for rotatably driving the rotor 5 is similar to the vibrating member 4 for rotatably driving the rotor 3, and descriptions thereof are therefore omitted, but this vibrating member 4 is similarly provided so as to come into contact with the outer peripheral surface 531 of the driven member 53 at the convexity 46.

The rotor 5 rotates in the opposite direction from the rotor 3; specifically, counterclockwise as seen in a plane (not shown) (as seen from the lower side in FIG. 2), due to the driving of the vibrating member 4.

When the rotor 3 rotates clockwise in FIG. 5, lift acts on the rotary wings 34, and when the rotor 5 rotates in the opposite direction from the rotor 3, lift acts on the rotary wings 54, and the miniature aircraft 1 rises into the air (flies) as a result of this lift.

A rotational frequency detection device for detecting the rotational frequency (rotational speed) of the rotor 3 is preferably provided in the vicinity of the rotor 3, and a rotational frequency detection device for detecting the rotational frequency (rotational speed) of the rotor 5 is preferably provided in the vicinity of the rotor 5.

Thus, the vibrating member 4 has a simple structure, and is small (particularly thin) and lightweight. Also, the drive force is strong because the driven members 33 and 53 are driven by the above-described frictional force (press force), unlike when they are driven by magnetic force as with a normal electromagnetic motor.

Also, as shown in FIG. 2, cables 471 and 472 are connected (electrically connected) to the vibrating member 4 with this configuration. The cable 471 is connected to the piezoelectric element 44, and the cable 472 is connected to the piezoelectric element 42. As previously described, the vibrating member 4 is connected to the drive control circuit 9 via the cables 471 and 472, and AC voltage is applied from the drive control circuit 9. The cables 471 and 472 have substantially identical functions, and therefore the cable 471 is described as a typical example.

A hollow part (hollow) 221 is formed in the center axle 22 along the longitudinal direction. Also, a hole 222 communicated with the hollow part 221 is formed in the outer periphery of the center axle 22.

Also, a hole 212 running vertically through the base plate 21 is formed in the base plate 21 near the center axle 22.

As shown in FIG. 2, the cable 471 passes through (runs through) the hole 212 in the base plate 21, the hole 222 in the center axle 22, and the hollow part 221 in order from the location where it connects with the vibrating member 4 (the piezoelectric element 44), and reaches the drive control circuit 9.

As a result of such wiring (cabling), the cable 471 can be easily positioned. Also, the cable 471 can thereby be prevented from being exposed or suppressed in its ability to be exposed, whereby the cable 471 can be prevented from winding around the center axle 22 or the rotary wings 34, for example.

Also, the path of the cable 471 from the vibrating member 4 to the drive control circuit 9 can be shortened, whereby the length of the cable 471 can be reduced (controlled).

The miniature aircraft 1 of the present invention is extremely advantageous for miniaturization because the vibrating member 4 is used to rotatably drive the rotors 3 and 5. It is also advantageous for weight reduction, and the miniature aircraft 1 can lift a greater payload (load). Manufacturing costs can also be reduced.

Also, in the present embodiment, as previously described, the driven member 33 is joined to the cylindrical member 31, and the driven member 33 is integrated with the rotor 3. Specifically, the vibrating member 4 directly drives the rotor 3 in a rotational manner, and no drive transmission mechanism or speed reduction mechanism is provided (necessary). The vibrating member 4 in the vicinity of the rotor 5 is similarly directly driven in a rotatable manner, and no drive transmission mechanism or speed reduction mechanism is provided (necessary). The miniature aircraft 1 thereby has a particularly simple structure, is lightweight, and is particularly advantageous in miniaturization and weight reduction (ensuring payload).

As previously described, since the vibrating members 4 have a strong drive force, they can rotate the rotors 3 and 5 with sufficient torque without a speed reduction mechanism (deceleration mechanism) as in the present embodiment.

Also, in the present embodiment, since the in-plane vibration of the vibrating members 4 is converted directly to the rotation (in-plane rotation) of the rotors 3 and 5, the energy loss associated with this conversion is small, and the rotors 3 and 5 can be rotatably driven with high efficiency.

Also, in the present embodiment, the direction of the frictional force (press force) exerted by the convexity 46 on the driven member 33 is substantially orthogonal to the rotational centerline 36, and the rotor 3 thereby rotates more smoothly and reliably without any force acting to tilt the rotor 3. Similarly, the rotor 5 also rotates more smoothly and reliably.

Unlike the depicted configuration, the vibrating member 4 for rotatably driving the rotor 3 may also be disposed so as to come into contact with the upper surface or lower surface of the driven member 33 from a direction parallel to the rotational centerline 36, and the vibrating member 4 for rotatably driving the rotor 5 may be disposed so as to come into contact with the upper surface or lower surface of the driven member 53 from a direction parallel to the rotational centerline 36.

Also, since the two lift forces of the rotor 3 and rotor 5 are created, a strong lift is obtained.

As a result of the rotor 3 and the rotor 5 rotating in opposite directions, the reactive force borne by the miniature aircraft 1 (the base parts 2) is balanced out, and the miniature aircraft 1 can be prevented from rotating around the rotational centerline 36.

Particularly, since the vibrating member 4 for the rotor 3 and the vibrating member 4 for the rotor 5 are provided separately, the rotational frequency (rotational speed) of the rotor 3 and the rotational frequency (rotational speed) of the rotor 5 can be adjusted (controlled) separately, whereby the miniature aircraft 1 (base parts 2) can be more reliably prevented from rotating around the rotational centerline 36, and the rotation (orientation) of the miniature aircraft 1 around the rotational centerline 36 can be controlled.

Also, as a result of the rotor 3 and the rotor 5 being provided coaxially, providing two rotors does not induce an increase is size or weight, and the effects described above can still be achieved. Specifically, this is advantageous in miniaturization and weight reduction.

In the depicted configuration, the rotor 3 and the rotor 5 have the same diameter, number of wings (two), shape of the wings, and other such conditions, but these conditions may be different.

The frequency of the AC voltage applied to the piezoelectric elements 42 and 44 is not particularly limited, but is preferably substantially equal to the resonance frequency of the vibration of the vibrating members 4 (for example, longitudinal vibration). The amplitude of the vibrating members 4 thereby increases, and the rotors 3 and 5 can be driven with high efficiency.

As previously described, the vibrating members 4 primarily vibrate in the longitudinal direction, but it is more preferable to simultaneously induce longitudinal vibration and bending vibration, and to cause the convexity 46 to move in an elliptical pattern (elliptical vibration). The rotors 3 and 5 can thereby be rotatably driven more effectively. Regarding these points, the vibrating member 4 for rotatably driving the rotor 3 will now be described as a typical example.

When the vibrating member 4 rotatably drives the driven member 33, the convexity 46 receives the reactive force from the driven member 33. In the present embodiment, since the convexity 46 is provided at a location displaced from the centerline 49 of the vibrating member 4, the vibrating member 4 deforms and vibrates (bending vibration) as a result of this reactive force so as to bend in the in-plane direction as shown by the single dashed line in FIG. 5. In FIG. 5, the deformation of the vibrating member 4 is shown in an exaggerated manner.

Also, the frequency of the applied voltage, the shape and size of the vibrating members 4, the position of the convexity 46, and other such factors can be appropriately selected, whereby complex vibration consisting of the longitudinal vibration and bending vibration of the vibrating members 4 can be induced. For example, the amplitude increases while the convexity 46 is displaced in a substantially elliptical pattern (elliptical vibration), as shown by the single dashed line in FIG. 6.

Thereby, during one vibration of the vibrating member 4, the convexity 46 is strongly pressed on by the driven member 33 when the convexity 46 sends the driven member 33 in the rotation direction, and the frictional force with the driven member 33 can be reduced or eliminated when the convexity 46 returns. Therefore, the vibration of the vibrating member 4 can be converted to the rotation of the rotor 3 with greater efficiency.

In the present embodiment, the rotor 3 is rotatably driven directly by the vibrating member 4, but the present invention also allows the vibrating member 4 to drive the rotor 3 intermittently. Specifically, the driven member 33 may be provided separately from the rotor 3, and the rotational force of the driven member 33 may be transmitted to the rotor 3 by a rotational force transmitting mechanism. Similarly, in the present embodiment, the rotor 5 is rotatably driven directly by the vibrating member 4, but the present invention also allows the vibrating member 4 to drive the rotor 5 intermittently. Specifically, the driven member 53 may be provided separately from the rotor 5, and the rotational force of the driven member 53 may be transmitted to the rotor 5 by a rotational force transmitting mechanism. In these cases, a winding transmission mechanism, or any other mechanism that uses a gear train (gear transmission mechanism), pulley, belt, chain, or the like may be used as the rotational force transmission mechanism.

Also in the present embodiment, one vibrating member 4 for rotatably driving the rotor 3 is provided, but the present invention also allows a plurality of these vibrating members 4 to be provided, and the driven member 33 to be rotatably driven by this plurality of vibrating members 4. Similarly, in the present embodiment, one vibrating member 4 for rotatably driving the rotor 5 is provided, but the present invention also allows a plurality of these vibrating members 4 to be provided, and the driven member 53 to be rotatably driven by this plurality of vibrating members 4.

As shown in FIGS. 1 and 3, the orientation stabilizer 19 has a stabilizer bar (rectangular mass) 191, a stabilizer joint (linking unit) 193 for linking the stabilizer bar 191 with the fixing part 522 provided with the rotary wings 54, and a support unit 194.

Spindles 192 are provided at both ends of the stabilizer bar 191. This stabilizer bar 191 has a moment of inertia in the rotational axial direction of the rotor 5 (z-axis direction) that is greater than that of the rotor 5.

The support unit 194 is disposed at the distal end (the end on the upper side) of the center axle 22 and allowed to rotate around the center axle 22. Specifically, the support unit 194 is disposed above the rotor 5.

Also, the stabilizer bar 191 disposed on the support unit 194 and allowed to rotate (oscillate) at a specific angle around an axle 195, which is substantially orthogonal to the rotational centerline (rotational center axis) 36 of the rotor 5. Also, the stabilizer bar 191 is disposed in a state of substantial equilibrium (balance).

The stabilizer bar 191 can thereby rotate substantially coaxially with the rotor 5, and can rotate at a specific angle around the axle 195 that is substantially orthogonal to the rotational centerline 36.

When the rotor 5 (a group of rotary wings 54) rotates, the stabilizer bar 191 is pulled by the rotor 5 via the stabilizer joint 193, and is caused to rotate with the rotor 5 (synchronously with the rotor 5). Specifically, the stabilizer bar 191 and the rotor 5 rotate in the same direction, with the axle 195 and axle 541 held at a constant angle.

Also, when the stabilizer bar 191 rotates around the axle 195, the fixing part 522 and the rotary wings 54 are pulled by the stabilizer bar 191 via the stabilizer joint 193, and rotate around the axle 541.

When the airborne miniature aircraft 1 undergoes a rapid or sudden (unexpected) disruption (change) in its airborne orientation, the disruption in airborne orientation is compensated for by the orientation stabilizer 19, whereby the airborne orientation of the miniature aircraft 1 can be stabilized.

For example, when the miniature aircraft 1 rapidly tilts in midair while rising in an airborne orientation in which the direction of the rotational centerline 36 is vertical, the stabilizer bar 191 struggles to maintain its horizontal position, and therefore rotates around the axle 195, and the fixing part 522 and the two rotary wings 54 also rotate around the axle 541 at the same time. The pitch of the rotary wings 54 thereby varies so that a difference in the airflow (air currents) in the rotary wings 54 is created to return the direction of the rotational centerline 36 to the vertical direction. The airborne orientation of the miniature aircraft 1 thereby returns to the original airborne orientation.

When the airborne orientation of the miniature aircraft 1 is varied by the orientation varying device (orientation changer) 16 described later, the center of gravity of the miniature aircraft 1 moves relatively slowly and the airborne orientation is varied. Therefore, the stabilizer bar 191 does not substantially rotate around the axle 195, and the orientation stabilizer 19 does not operate. The airborne orientation of the miniature aircraft 1 can thereby be reliably varied.

As shown in FIG. 1, the grounding device 6 includes a plate-shaped fixed part (connector) 60 that is fixed to the center axle 22, and four rod-shaped legs (grounding legs) 61 that have elasticity (spring properties).

The fixed part (connector) 60 is configured from a plate-shaped object. The fixed part 60 is provided to be substantially orthogonal to the center axle 22 in the reference orientation.

Also, the fixed part 60 is at a region (center axle 22) farther vertically above than the center of gravity (center of gravity of the miniature aircraft 1) in the reference orientation, and farther vertically above than the orientation varying device (orientation changer) 16 (x-axis direction movement device 16x, y-axis direction movement device 16y).

The legs 61 extend downward (vertically downward) at an incline in the orthogonal direction from the fixed part (connector) 60 in the reference orientation shown in FIG. 1, and expand downward in the orthogonal direction. Also, the legs 61 are disposed at equal intervals (equally angled intervals) centered on the fixed part 60 (center axle 22). The distal ends (lower side ends) 62 of the legs 61 are wider than the sections of the legs 61 at the upper side, and the distal ends 621 are rounded (curved).

The aircraft can touch down in a stable manner on the ground (floor) by the grounding device 6, and landing can be performed easily and reliably.

Particularly, during landing, the impact of landing can be absorbed by the elasticity of the legs 61, and the aircraft can be prevented from overturning because the orientation of the miniature aircraft 1 is corrected by the spring force of the first grounded leg 61 if the miniature aircraft 1 lands at a tilted position.

Next, the orientation varying device 16 will be described.

The orientation varying device 16 shown in FIGS. 1 and 7 varies (regulates) the orientation of the miniature aircraft 1 by moving the center of gravity, whereby the rotational centerlines (rotational center axes) 36 of the rotors 3 and 5 are tilted at specific angles in specific directions in relation to a vertical line (vertical direction: direction of gravity) (the tilt is controlled).

As shown in FIG. 1, the orientation varying device 16 is disposed below the rotary wings 34. Specifically, the orientation varying device 16 is disposed (fixed) at the lower end of the center axle 22.

The orientation varying device 16 in the present embodiment has a spindle element (spindle (main body unit)) 14, a linear actuator (first linear actuator) 16y, which is a y-axis direction movement device (y-axis direction displacement device) for moving the spindle element 14 in the direction of the y-axis, and a linear actuator (second linear actuator) 16x, which is an x-axis direction movement device (x-axis direction displacement device) for moving (displacing) the linear actuator (y-axis direction movement device) 16y and the spindle element 14 in the direction of the x-axis.

A movement device (displacement device (displacement mechanism)) for moving (displacing) the spindle element 14 in relation to the miniature aircraft 1 is configured from the linear actuators 16x and 16y.

As shown in FIG. 7, the linear actuator 16x and the linear actuator 16y are connected to each other via one pin (connecting member) 186 in a state in which the sliders 181 described later face each other.

The pin 186 is configured from a pillar-shaped pin main body 186a, and flanges 186b formed at both ends. The flanges 186b are provided with holes 186c.

The linear actuator 16y and the sliders 181 are linked via bolts (not shown) so that the holes 186c of the flanges 186b coincide with the holes 185 of the sliders 181 of the linear actuator 16y (see FIG. 8). Also, the linear actuator 16x and the sliders 181 are linked via bolts (not shown) so that the holes 186c of the flanges 186b coincide with the holes 185 of the sliders 181 of the linear actuator 16x (see FIG. 8). As a result of such a configuration, the sliders 181 are linked to each other.

Also, the linear actuator 16x and the linear actuator 16y are connected so that the directions in which the sliders 181 move are perpendicular to each other, specifically, so that the slider 181 of the linear actuator 16x moves in the direction of the x-axis, and the slider 181 of the linear actuator 16y moves in the direction of the y-axis.

Also, in the orientation varying device 16, the linear actuator 16x is disposed at the top and the linear actuator 16y is disposed at the bottom, and the upper side of the linear actuator 16×at the middle of the base 161 described later is connected with the lower end of the center axle 22, as shown in FIG. 1. The spindle element 14 is then connected to the lower side of the linear actuator 16y at the middle of the base 161 described later.

Next, the linear actuator 16y will be described as a typical example of the linear actuator 16y and the linear actuator 16x.

As shown in FIGS. 8 through 10, the linear actuator 16y has a plate-shaped base 161, a plate-shaped base stand 171, a plate-shaped slider 181, and a vibrating member (drive source) 4. The base 161, base stand 171, slider 181, and vibrating member 4 are disposed so as to be substantially parallel to each other (including when they partially overlap in the plane direction).

The base stand 171 is disposed in the middle of the base 161 and allowed to move to the left and right in FIG. 10 in relation to the base 161. In this case, a pair of guide pins 162 is placed in the middle of the base 161 along the horizontal direction in FIG. 10, and a pair of long holes 172 extending to the left and right in FIG. 10 is formed in the base stand 171 along the horizontal direction in FIG. 10. The guide pins 162 are inserted through the corresponding long holes 172. The base stand 171 can thereby be guided by the guide pins 162 to move to the left and right in FIG. 10 along the long holes 172.

The vibrating member 4 for rotatably driving a rotor 164 (driven member 165) described later is mounted on the base stand 171. The vibrating member 4 has a convexity (contact part) 46 and a pair of arms 48, and is fixed in place on the base stand 171 by bolts 175 inserted through holes 481 formed in the arms 48, so that the convexity 46 faces to the right in FIG. 10. The vibrating member 4 can thereby be supported on the arms 48 so as to allow vibration.

Also, a pair of spring stopping pins 168 is placed at the ends of the base 161 at the upper side in FIGS. 8 and 9. A pair of spring holders 173 is also formed in the base stand 171. One of the spring holders 173 is provided to the left side of the base stand 171 in FIG. 9, and the other spring holder 173 is provided to the right side of the base stand 171 in FIG. 9.

The corresponding spring stopping pins 168 and spring holders 173 are all disposed in a state in which coil springs 174 (urging devices) are extended (are in an extended state). Specifically, the coil springs 174 are held (fixed) at one end by the spring holders 173 of the base stand 171, and the other ends are mounted (fixed) on the spring stopping pins 168 of the base 161.

The base 161 is urged toward the upper side in FIGS. 8 and 9 by the elastic force (recoil force) of the coil springs 174, and the convexity 46 of the vibrating member 4 is pressed on while in contact with the outer peripheral surface 1651 of the driven member 165 to be described later.

Also, a rotor 164 is rotatably mounted on the end of the base 161 at the upper side in FIGS. 8 and 9, and in the horizontal middle in FIG. 9.

The rotor 164 has a cylindrical part 166 in a substantially cylindrical shape, a driven member 165 joined (fixed) to the outer side (outer periphery) of the cylindrical part 166, and circular plate parts 1691 and 1692 in the shape of circular plates.

The driven member 165 has a substantial ring shape (annular shape) and is disposed at a location corresponding to the vibrating member 4 (proximal end side).

As shown in FIG. 10, the circular plate part 1691 is fixed in place at the top of the cylindrical part 166. The circular plate part 1691 gradually decreases in diameter near the bottom. Specifically, the lateral surface of the circular plate part 1691 is tapered.

The circular plate part 1692 is fixed at the middle of the cylindrical part 166. The circular plate part 1692 gradually decreases in diameter at the top. Specifically, the top lateral surface of the circular plate part 1692 is tapered.

A pinion gear 167 is formed in the outer peripheral surface of the rotor 164 (cylindrical part 166) on the distal end side. The driven member 165 and the pinion gear 167 thereby rotate integrally when the rotor 164 rotates.

The diameter (external diameter) of the area (the gear as a rotating member) on which the pinion gear 167 of the rotor 164 is formed is set to be less than the diameter (external diameter) of the driven member 165, whereby a deceleration mechanism is configured.

The moving speed of the slider 181 can be arbitrarily adjusted (varied) by adjusting (varying) the ratio between the diameter of the area (the gear as a rotating member) of the rotor 164 where the pinion gear 167 is formed, and the diameter of the driven member 165.

Two rotors 163 having grooves 1631 are rotatably mounted at the ends (corners) of the base 161 at the lower side in FIGS. 9 and 10. In the grooves 1631, the (vertical) sidewalls that face each other are tapered in the same manner as the lateral surfaces of the circular plate part 1691 (circular plate part 1692).

The slider 181 is disposed in the grooves 1631 of these rotors 163, is held between the rotors 163 and the rotor 164, and is mounted to be capable of moving to the left and right in FIG. 9 in relation to the base 161. Specifically, the slider 181 is controlled so that it is moved to the left and right in FIG. 9 and kept in the constant orientation by the rotors 163 and the rotor 164.

As shown in FIGS. 8 and 9, the slider 181 is configured from a plate-shaped object in the shape of a horizontal “H.” The slider 181 has a first slider part 187, a second slider part 188, and a linking part 189 for linking the first slider part 187 and the second slider part 188.

Also, a rack gear 183 that meshes with the pinion gear 167 provided to the rotor 164 is formed on the distal surface of the outer side of the first slider part 187 of the slider 181, along the moving direction of the slider 181. The rotational movement of the rotor 164 is converted to the linear movement of the slider 181 by the rack gear 183 and the pinion gear 167. Therefore, a rotation/movement conversion mechanism is configured from the rack gear 183 and the pinion gear 167.

The vertical position (in the direction of the z-axis) of the rack gear 183 (first slider part 187) is controlled in order for the rack gear 183 to fit in between the tapered side of the above-described circular plate part 1691 and the tapered side of the circular plate part 1692. The rack gear 183 can thereby be prevented from separating from the pinion gear 167.

Also, the meshing depth of the rack gear 183 and the pinion gear 167 can be controlled (managed) by appropriately setting the taper angle.

The end surface of the outer side of the second slider part 188 of the slider 181 is inclined so as to run along the tapered sides of the previously described grooves 1631. The vertical position (in the direction of the z-axis) of the second slider part 188 can thereby be controlled, and the second slider part 188 can be prevented from separating from the rotors 163.

Also, protrusions 184 (stoppers) are formed at both ends of the second slider part 188 of the slider 181. The range of movement of the slider 181 is restricted (movement past a specific position is prevented) by these protrusions 184, and the slider 181 is inhibited in its ability to separate (is prevented from separating).

Also, two holes 185 corresponding to the holes 186c of the pin 186 are formed in the linking part 189 of the slider 181.

The width of the slider 181 (the length in the vertical direction in FIG. 9) is preferably set to be comparatively large. Deformations in the base 161 (base surface) and the slider 181 (slider surface) can thereby be reduced.

When the vibrating member 4 in the linear actuator 16y vibrates according to a specific pattern, rotational force (drive force) in a specific direction is repeatedly exerted on (applied to) the driven member 165 from the convexity 46 (via the convexity 46) as a result of this vibration, and the rotor 164 rotates in a specific direction. The rotational movement of the rotor 164 is converted to linear movement of the slider 181 by the pinion gear 167 provided to the rotor 164 and the rack gear 183 provided to the slider 181, and the slider 181 is guided by the rotors 163 to move in a specific direction (for example, forward in the direction of the y-axis). Specifically, the base 161 and the spindle element 14 move integrally relative to the slider 181.

When the vibrating member 4 is excited so that vibration is reversed, rotational force in an opposite direction from the previous direction is repeatedly exerted on the driven member 165 from the convexity 46, and the rotor 164 rotates in the opposite direction from the previous direction. The rotational movement of the rotor 164 is converted to linear movement of the slider 181 by the pinion gear 167 provided to the rotor 164 and the rack gear 183 provided to the slider 181, and the slider 181 is guided by the rotors 163 to move in the opposite direction from the previous direction (for example, backward in the direction of the y-axis). Specifically, the base 161 and the spindle element 14 move integrally relative to the slider 181.

With the linear actuator 16y, miniaturization (particularly, thinning) and size reduction can be ensured in a simple structure, and a strong drive force can be obtained at low speeds.

The spindle element 14, that is, the center of gravity, can thereby be moved easily and reliably at low speeds, whereby the orientation of the miniature aircraft 1 can be varied accurately and reliably, and the aircraft can fly in a stable manner.

Also, since the slider 181 and the vibrating member 4 can be disposed in an overlapping manner, the total surface area of the linear actuator 16y can be reduced, which is advantageous for miniaturization.

For example, when the linear actuator is one in which the contact part of the vibrating member comes into contact with the slider, and the slider is moved directly, the force by which the vibrating member presses against the slider constitutes resistance when the slider moves. With the linear actuator 16y, however, the load from the vibrating member 4 acting on the slider 181 can be removed, so the driving of the linear actuator 16y can be stabilized and the aircraft can be flown in a more stable manner.

When a linear actuator designed to directly move the slider is used, the slider is configured from metal in order to reduce the friction of the slider against the contact part of the vibrating member, which is disadvantageous for reducing the weight of the linear actuator 16y, but since the vibrating member 4 does not directly drive the slider 181 with this linear actuator 16y, the slider 181 can be configured from a resin or another such lightweight material, and the linear actuator 16y can thereby be made more lightweight, that is, the miniature aircraft 1 can be made more lightweight.

The linear actuator 16x is similar to the linear actuator 16y, and therefore descriptions thereof are omitted.

In the present invention, one of either the linear actuator 16y or the linear actuator 16×may be omitted.

In the vibrating member 4 of the orientation varying device 16, in-plane longitudinal or bending vibration can be arbitrarily selected by dividing the electrodes into a plurality of groups, selectively applying a voltage to the groups of electrodes, and partially driving the piezoelectric element. Specifically, the configuration is designed so that the direction of the vibration (vibration displacement) of the convexity 46 of the vibrating member 4 is changed by varying the state of conduction to the vibrating member 4 (the vibration pattern of the vibrating member 4), whereby the driven member 165 can be rotated either clockwise or counterclockwise in FIG. 9 (in the forward or reverse direction). The vibrating member 4 is described below. The description focuses on the differences with the vibrating members 4 for rotatably driving the rotors 3 and 5, and descriptions of similar aspects are omitted.

As shown in FIG. 12, the vibrating member 4 has a layered structure with a piezoelectric element 42 on the upper side of the reinforcing plate 43 in FIG. 12, and a piezoelectric element 44 on the lower side, similar to the vibrating members 4 for rotatably driving the rotors 3 and 5, but this vibrating member differs from the vibrating members 4 for rotatably driving the rotors 3 and 5 in that four plate-shaped electrodes 41a, 41b, 41c, and 41d are placed on the upper side of the piezoelectric element 42 in FIG. 12, and four plate-shaped electrodes 45a, 45b, 45c, and 45d (the electrodes 45a, 45b, 45c, and 45d are not shown, but only the reference symbols are indicated in parentheses) are placed on the lower side of the piezoelectric element 44 in FIG. 12. Specifically, the piezoelectric element 42 is divided (segmented) into four substantially equal rectangular regions, with the rectangular electrodes 41a, 41b, 41c, and 41d placed in the divided regions, and, similarly, the piezoelectric element 44 is divided (segmented) into four substantially equal rectangular regions, with the rectangular electrodes 45a, 45b, 45c, and 45d placed in the divided regions. The electrodes 45a, 45b, 45c, and 45d are disposed on the reverse sides of the electrodes 41a, 41b, 41c, and 41d, respectively.

The electrodes 41a and 41c at the opposite ends of one diagonal, and the electrodes 45a and 45c disposed on the reverse sides thereof, are all electrically connected and are designed to be simultaneously conductive. Similarly, the electrodes 41b and 41d at the opposite ends of the other diagonal, and the electrodes 45b and 45d disposed on the reverse sides thereof, are all electrically connected (hereinafter similarly referred to as “connected”) and are designed to be simultaneously conductive.

The reinforcing plate 43 is earthed (grounded), and is configured so that the electrodes 41a, 41c, 45a, and 45c, and the electrodes 41b, 41d, 45b, and 45d to be charged are switched with a switch (not shown), and AC voltage is applied to either of the sets. Specifically, as shown in FIG. 15, the vibrating member 4 is connected to a drive control circuit 9, described later, which has the aforementioned switch (not shown), the electrodes to be charged are selected (switched) by this drive control circuit 9, and alternating current is applied.

The convexity 46 is provided to the widthwise middle of the reinforcing plate 43 (middle of the narrow side) on the right end of FIG. 12 (the narrow side).

Also, a pair of (two) arms 48 having elasticity (flexibility) is formed integrally in the reinforcing plate 43. The pair of arms 48 is provided near the longitudinal (the horizontal direction in FIG. 12) middle of the reinforcing plate 43 so as to protrude in directions substantially orthogonal to the longitudinal direction, and in opposite directions from each other (vertically symmetrical in FIG. 12) via the reinforcing plate (vibrating member 4).

When the electrodes 41a, 41c, 45a, and 45c of the vibrating member 4 are charged, and AC voltage is applied between the reinforcing plate 43 and the electrodes 41a, 41c, 45a, and 45c, the sections of the vibrating member 4 corresponding to the electrodes 41a, 41c, 45a, and 45c repeatedly expand and contract in the direction of the arrow a as shown in FIG. 13, whereby the convexity 46 of the vibrating member 4 either vibrates in an inclined direction shown by the arrow b (two-way movement), or vibrates in an elliptical patter as shown by the arrow c (elliptical movement). The driven member 165 receives the frictional force (press force) from the convexity 46 during expansion of the sections of the vibrating member 4 that correspond to the electrodes 41a, 41c, 45a, and 45c.

Specifically, a large frictional force is applied between the convexity 46 and the outer peripheral surface 1651 by the diametral component S1 of the vibration phase S of the convexity 46 (the diametral displacement of the driven member 165), and the counterclockwise rotational force in FIG. 13 is applied to the driven member 165 by the peripheral component S2 of the vibration phase S (circumferential displacement of the driven member 165).

When the vibrating member 4 vibrates, this force repeatedly acts on the driven member 165, and the driven member 165 rotates counterclockwise in FIG. 13. The rotor 164 thereby rotates counterclockwise in FIG. 13.

Conversely, when the electrodes 41b, 41d, 45b, and 45d of the vibrating member 4 are charged, and AC voltage is applied between the reinforcing plate 43 and the electrodes 41b, 41d, 45b, and 45d, the portions of the vibrating member 4 corresponding to the electrodes 41b, 41d, 45b, and 45d all repeatedly expand and contract in the direction of the arrow a, whereby the convexity 46 of the vibrating member 4 either vibrates in an inclined direction shown by the arrow b (two-way movement), or vibrates in an elliptical patter as shown by the arrow c (elliptical movement). The driven member 165 receives the frictional force (press force) from the convexity 46 during expansion of the sections of the vibrating member 4 that correspond to the electrodes 41b, 41d, 45b, and 45d.

Specifically, a large frictional force is applied between the convexity 46 and the outer peripheral surface 1651 by the diametral component S1 of the vibration phase S of the convexity 46 (the diametral displacement of the driven member 165), and clockwise rotational force in FIG. 14 is applied to the driven member 165 by the peripheral component S2 of the vibration phase S (circumferential displacement of the driven member 165).

When the vibrating member 4 vibrates, this force repeatedly acts on the driven member 165, and the driven member 165 rotates clockwise in FIG. 14. The rotor 164 thereby rotates clockwise in FIG. 14.

In FIGS. 13 and 14, the deformation of the vibrating member 4 is shown in an exaggerated manner, and the arms 48 are not shown.

In the present embodiment, an example was described in which the electrodes of the vibrating member 4 were divided into four pieces, but this example is nonlimiting, and the present invention is not limited to the previously described structure or drive method of the vibrating member 4.

Also, the linear actuators 16x and 16y both have a position detection device (travel distance detection device) (not shown) for detecting the position (travel distance) of the slider 181 (spindle element 14) in the direction of the x-axis and the position (travel distance) in the direction of the y-axis. The position detection devices are both configured from a cable for detecting the specific position and a sensor having a light-emitting element and a light-receiving element.

When the vibrating member 4 of the linear actuator 16x is driven and the slider 181 moves, a signal from the sensor is supplied (inputted) to a y-direction control circuit 92y of the drive control circuit 9 to be described later, and the y-direction control circuit 92y determines the travel distance or the position of the slider 181 (spindle element 14) in the direction of the y-axis on the basis of this signal. The information of the travel distance or position of the slider 181 (spindle element 14) is used for specific controlling or processing when the slider 181 (spindle element 14) is moved in the direction of the y-axis.

Similarly, when the vibrating member 4 of the linear actuator 16y is driven and the slider 181 moves, a signal from the sensor is supplied (inputted) to an x-direction control circuit 92x of the drive control circuit 9 to be described later, and the x-direction control circuit 92x determines the travel distance or the position of the slider 181 (spindle element 14) in the direction of the x-axis on the basis of this signal. The information of the travel distance or position of the slider 181 (spindle element 14) is used for specific controlling or processing when the slider 181 (spindle element 14) is moved in the direction of the x-axis.

The position detection devices are not limited to optical detection, and may, for example, be designed for magnetic detection.

The configurations of the linear actuators 16x and 16y are not limited to those previously described, and the configuration shown in FIG. 11, for example, may be used. The linear actuator 16y was described as a typical example of the linear actuator 16y and the linear actuator 16x. The description focuses on differences with the linear actuator 16y shown in FIG. 9, and descriptions of similar aspects are omitted.

As shown in FIG. 11, the slider 181 in the linear actuator 16y has a substantially square frame shape. Specifically, a substantially square-shaped opening 182 is provided in the middle of the slider 181. It is thereby possible to reduce the weight. The vibrating member 4 can also be attached and removed using this opening 182, and maintenance is improved.

A rack gear 183 that meshes with the pinion gear 167 provided to the rotor 164 is formed in the end on the inner side of the slider 181 on the right side in FIG. 11, along the direction in which the slider 181 moves.

Also, the slider 181 is configured so that it is held from the inside by the rotor 164 and the rotors 163 (the slider 181 is sandwiched between the rotor 164 and the rotors 163) to prevent interference between the vibrating member 4 and the slider 181, as seen in a plane (in FIG. 11).

The thickness of the entire linear actuator 16y can thereby be further reduced.

Next, the spindle element 14 will be described.

As shown in FIG. 1, the spindle element 14 has a circuit board (flexible circuit board) 13 having specific circuits, a holding frame 141 for holding the circuit board 13, and a storage battery (battery, energy reserve unit) 15 as an energy storage device for storing energy to drive the miniature aircraft 1.

The circuit board 13 is provided, for example, with the drive control circuit 9 shown in FIG. 15, and a drive circuit for the orientation control sensor 8 or the like.

The storage battery (energy reserve unit) 15 is in the shape of a plate (block). The storage battery 15 is connected to the circuit board 13 via a flat cable (not shown). Electricity is thereby supplied to the circuit board 13 and other components of the miniature aircraft 1.

The holding frame 141 is in the shape of a substantially rectangular prism. A hollow part 142 in the shape of a substantially rectangular prism that runs through the holding frame 141 is formed in the holding frame 141.

Part of the circuit board 13 (for example, the base plate of the orientation control sensor 8 or the like) is provided (fixed) to the side surface 143 of the holding frame 141 in which the hollow part 142 is not formed, and the bottom surface 144 of the holding frame 141. Specifically, part of the circuit board 13 is formed along the outer periphery of the holding frame 141. The surface area of the circuit board 13 can thereby be increased, and a large number of circuits (circuit patterns) can therefore be formed in the circuit board 13.

Part of the circuit board 13 (for example, the BT base plate or the like) is similarly provided (fixed) in the hollow part 142. The circuit board 13 is provided so that the hollow part 142 is vertically partitioned in two. The inner sides of the holding frame 141 (the hollow part 142) can thereby be efficiently utilized.

Also, pawls (nail) 145 are provided to each of the four corners of the bottom surface 144 of the holding frame 141. The pawls 145 are formed so as to engage with the edges (corners) 151 of the storage battery (energy reserve unit) 15. The storage battery 15 is thereby supported in a detachable manner, and the storage battery (energy reserve unit) 15 is easily replaced.

The mass of the spindle element 14 with this configuration accounts for a large part of the mass of the miniature aircraft 1, and therefore the center of gravity can easily be moved by moving the spindle element 14. As shown in FIG. 15, the orientation control sensor 8 is configured from a gyro sensor 81z for detecting rotation around the Z-axis (θz direction), an acceleration sensor 81x for detecting acceleration in the direction of the x-axis (αx), and an acceleration sensor 81y for detecting acceleration in the direction of the y-axis (αy).

Also, the drive control circuit 9 is configured from a Oz detection circuit 91z, an αx detection circuit 91x, an ay detection circuit 91y, a θz control circuit 92z, an x-direction control circuit 92x, a y-direction control circuit 92y, a first drive circuit 931, a second drive circuit 932, a y-drive circuit 93y, an x-drive circuit 93x, a switch (not shown) for switching the electrodes of the linear actuator 16y made conductive by the vibrating member 4, and a switch (not shown) for switching the electrodes of the linear actuator 16x made conductive by the vibrating member 4.

The first drive circuit 931 is connected to the vibrating member 4 for rotatably driving the rotor 3, and the second drive circuit 932 is connected to the vibrating member 4 for rotatably driving the rotor 5. Also, the y-drive circuit 93y is connected to the vibrating member 4 of the linear actuator 16y via the switch for switching the electrodes, and the x-drive circuit 93x is connected to the vibrating member 4 of the linear actuator 16x via the switch for switching the electrodes. A cowling 7 in the shape of a dome (hemisphere) is fixed in place (provided) in the middle of the center axle 22, as shown in FIG. 1.

In the reference orientation (as shown in FIG. 1), the cowling 7 has a convexity facing vertically upward, and a cavity 73 (hollow part) that opens vertically downward.

As a result of the cowling 7 having a dome-shaped convexity 72, a preferred airflow can be obtained from the rotary wings 34 and 54, and the miniature aircraft 1 can therefore reliably achieve lift. Also, since the shape of the outer surface 71 is smooth, vortexes can be prevented from occurring in the airflow, specifically, the airflow can be controlled.

Since air flows smoothly along the outer surface 71, airflow resistance can be suppressed, and the consumption of the electricity in the storage battery 15 can therefore be suppressed.

Also, since the cowling 7 has a cavity 73, the fixing parts of the x-axis direction movement device 16x, the y-axis direction movement device 16y, and the grounding device can be inserted into the cavity 73, whereby the size (height) of the miniature aircraft 1 in the height direction (the vertical direction in FIG. 1) can be reduced (controlled). Also, inserting the x-axis direction movement device 16x and the y-axis direction movement device 16y into the cavity 73 makes it possible to protect both of these devices with the outer surface 71. When the miniature aircraft 1 is remote-controlled wirelessly, the cowling 7 can function as an antenna (parabolic antenna).

Also, the cowling 7 has a shape at which the center axis (centerline) thereof substantially coincides with the center axle 22, that is, the center axis is symmetrical with the center axle 22 as seen from the longitudinal direction. The airborne orientation (airborne state) of the miniature aircraft 1 can thereby be stabilized.

The structural material of the cowling 7 is not particularly limited, and various metal materials or various plastics (resin materials) or the like can be used singly or in combinations together. The cowling 7 can thereby be easily formed. Also, the drive control circuit 9 can be protected from sunlight or γ rays in the sky.

As shown in FIG. 1, the grounding locations 500 for grounding the miniature aircraft 1 are provided with two electrodes 200. The electrodes 200 are both connected to a power supply 201.

When the miniature aircraft 1 is grounded at the grounding locations 500 by the grounding device 6, the legs 61 are connected to the electrodes 200, and the legs 61 conduct electricity to the electrodes 200. At this time, the storage battery 15 stores electricity from the power supply 201 via a cable connecting the legs 61 and the storage battery 15.

Thus, electricity can be reliably stored in the miniature aircraft 1 (storage battery 15) every time the miniature aircraft 1 lands (is grounded) at the grounding locations 500 by providing the grounding locations 500 with the electrodes 200 and the power supply 201.

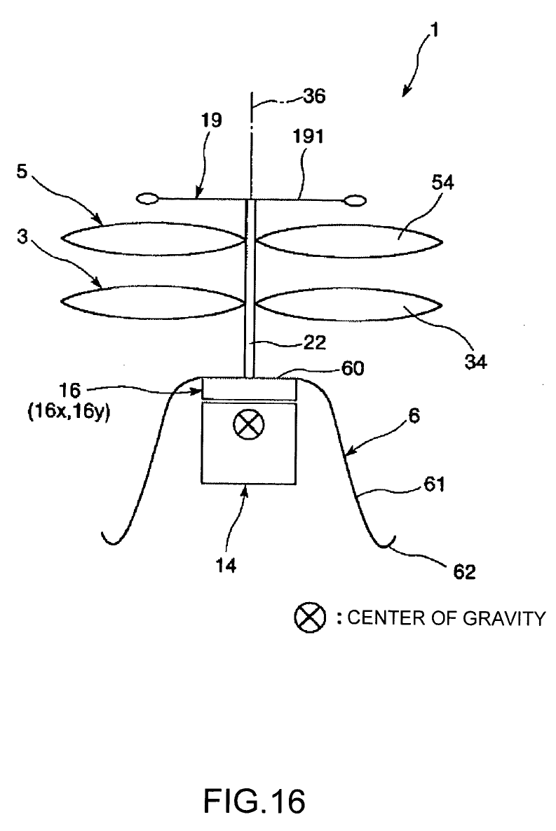

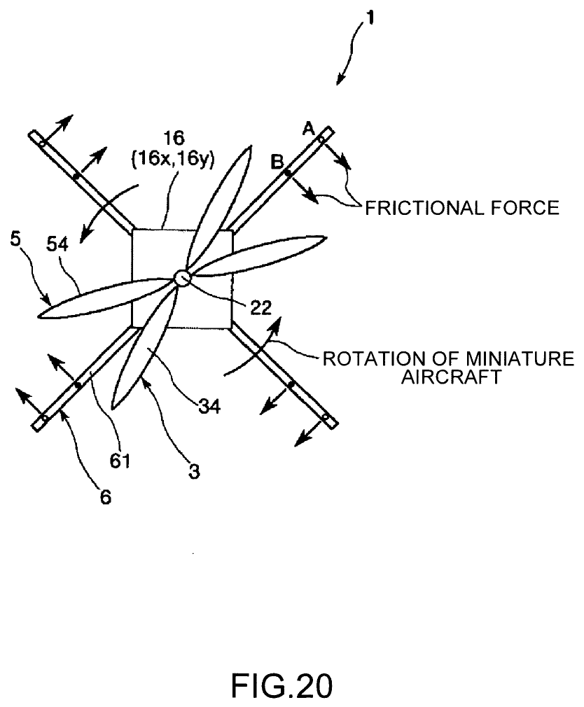

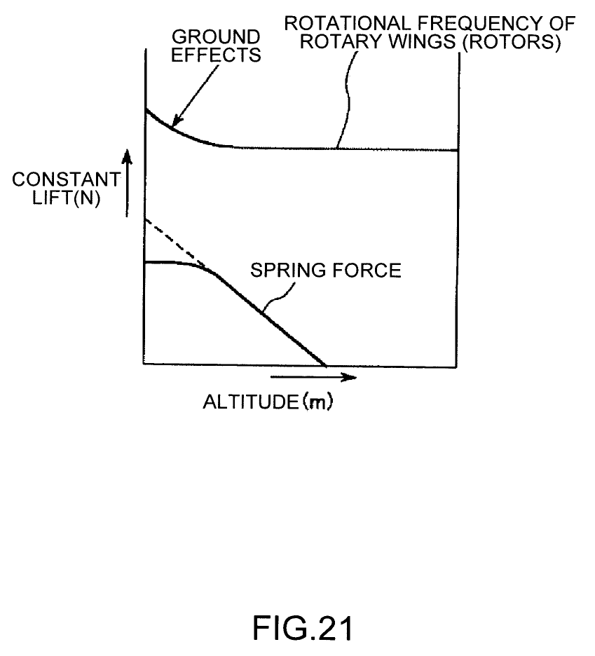

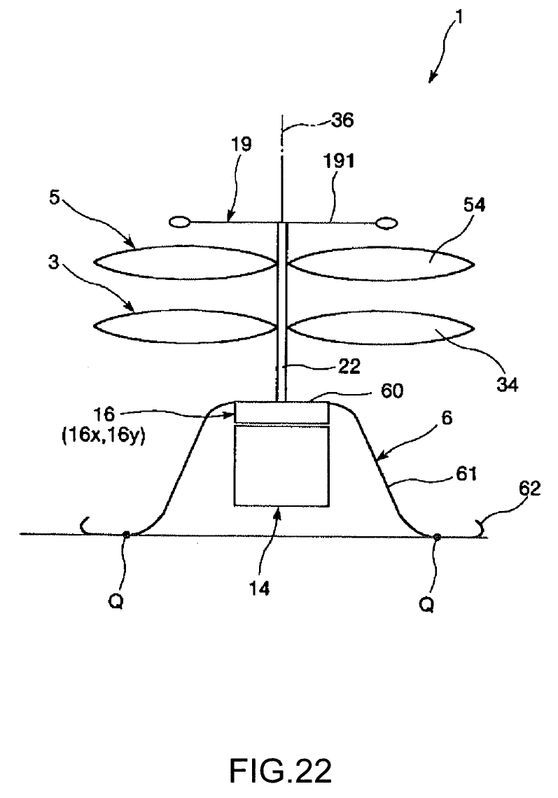

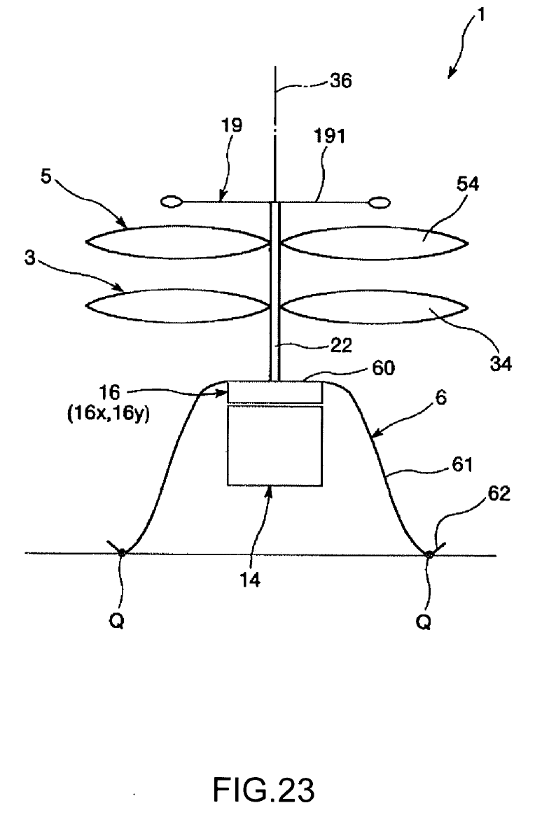

FIGS. 16 through 19 are schematic diagrams (side views) for describing the operation and the like of the miniature aircraft shown in FIG. 1. FIG. 20 is a schematic diagram (plan view) for describing the operation and the like of the miniature aircraft shown in FIG. 1, FIG. 21 is a graph showing the relationship between the altitude of the miniature aircraft and the lift when the spring force (elastic force) of the legs of the grounding device of the miniature aircraft shown in FIG. 1 and the rotational frequency of the rotary wings (rotor) are constant, and FIGS. 22 and 23 are schematic views (side views) for describing the operation and the like of the miniature aircraft shown in FIG. 1.

As shown in FIG. 16, the direction of the rotational centerline 36 is vertical when the position of the center of gravity lies on an extended line from the rotational centerline 36 (center axle 22). The lift at this time consists only of the vertical component (thrust).

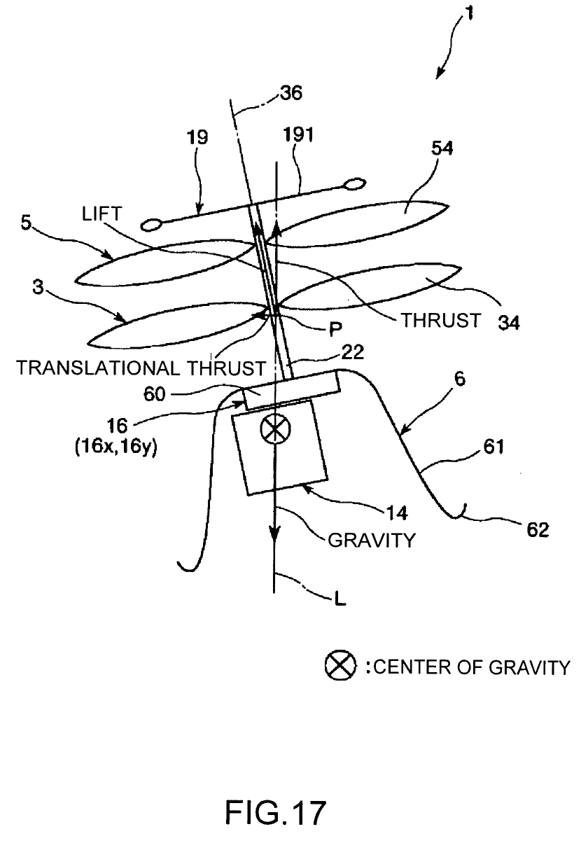

As shown in FIG. 17, when the center of gravity moves due to the movement (displacement) of the spindle element 14, the miniature aircraft 1 (rotational centerline 36) is inclined so that the direction of the straight line L that passes through the center of gravity and the fulcrum P at which the lift acts (occurs) is vertical. A horizontal component (translational thrust) is thereby created in the lifting force, and the miniature aircraft 1 moves horizontally.

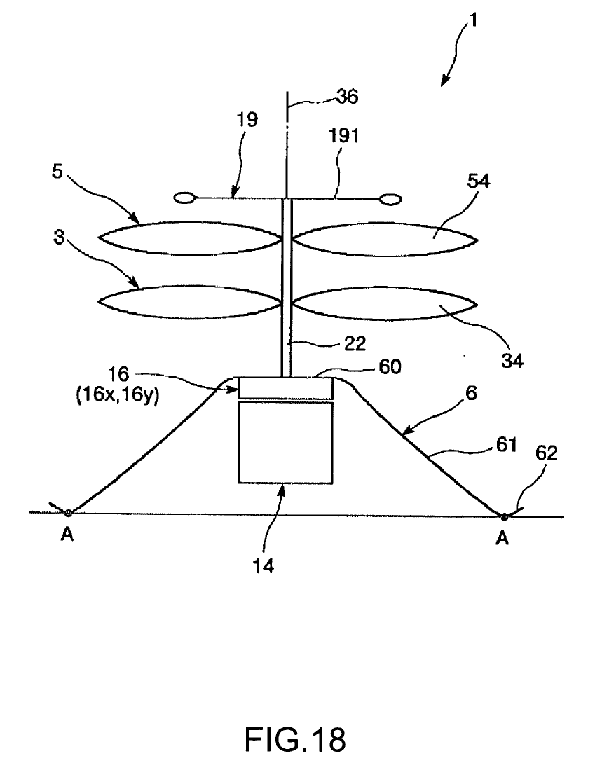

Also, as previously described, the legs 61 both have elasticity (spring properties), so when the lifting force is 0, as shown in FIG. 18, the legs 61 spread farther outward due to the weight of the miniature aircraft 1 than when the legs 61 are not in contact with the ground (floor (grounding locations 500)) (the natural state).

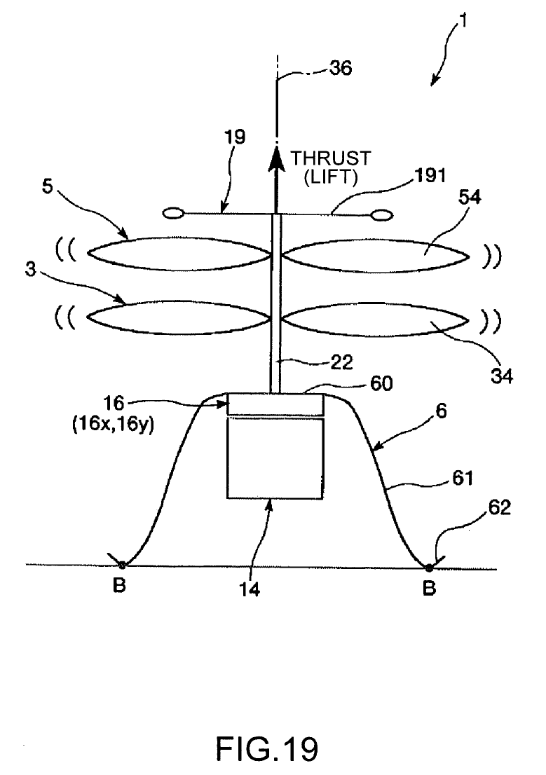

As shown in FIG. 19, when the rotary wings 34 and 54 (rotors 3 and 5) rotate to create lift, the force applied to the legs 61 is reduced with greater lift, the spaces between the legs 61 are narrowed by the recoil force (elastic force) of the legs 61, and the legs 61 approach the natural state.

As previously described, the legs 61 have already expanded (there is a large distance between the rotational centerline 36 and the grounding points of the legs 61 on the ground) at the start of rotation of the rotary wings 34 and 54 (rotors 3 and 5) for which there is no control of rotation around the rotational centerline 36 (z-axis) of the miniature aircraft 1; therefore, a strong force (moment) acts to suppress the rotation of the miniature aircraft 1 around the rotational centerline 36 as a result of the frictional force between the ground and the distal end parts 62 (distal ends 621) of the legs 61, as shown in FIG. 20. The miniature aircraft 1 is thereby inhibited in its ability to rotate about the rotational centerline 36 (the miniature aircraft 1 is forced to not rotate).

The rotational speed of the rotary wings 34 and 54 (rotors 3 and 5) then increases and the miniature aircraft 1 rises, and when the spaces between the legs 61 narrow (when the distance between the rotational centerline 36 and the point of contact between the legs 61 and the ground becomes shorter), there is a decrease in the force (moment) for suppressing the rotation of the miniature aircraft 1 as a result of the frictional force between the ground and the distal end parts 62. The miniature aircraft 1 thereby rises form a state in which the rotation of the miniature aircraft 1 is controlled, and a switch can gradually be made to controlling the rotation of the miniature aircraft 1 around the rotational centerline 36.

Also, during takeoff, the rising of the miniature aircraft 1 is aided (assisted) by the spring force (elastic force) of the legs 61.

At this time, as shown by the dotted line in FIG. 21, when the spring force of the legs 61 has a linear shape, at an altitude 0 where the influence of the effects of the ground is greatest, the spring force reaches a maximum, the assistance by the spring force becomes excessive, and the aircraft sometimes rises suddenly at the start of takeoff and is likely to lose balance. In view of this, it is preferable to have a configuration so that the spring force of the legs 61 has a nonlinear shape, and the spring force is saturated near the altitude 0. The rising of the miniature aircraft 1 can thereby be supported by the spring force of the legs 61, and takeoff can be executed smoothly.

Also, since the legs 61 all have elasticity (spring properties), when the lift is at 0, the legs 61 spread outward due to the weight of the miniature aircraft 1, and the contact points Q where the legs 61 come into contact with the ground are disposed on the proximal end side (the roots) of the legs 61, as shown in FIG. 22.

As shown in FIG. 23, when the rotary wings 34 and 54 (rotors 3 and 5) rotate to create lift, the force applied to the legs 61 is reduced as the lift increases, the spaces between the legs 61 become smaller, and the contact points Q where the legs 61 come into contact with the ground move toward the distal end side of the legs 61.

Specifically, when grounded, the legs 61 bend so that the position of the contact points Q where the legs 61 come into contact with the ground varies according to the load (weight) applied to the legs 61. The length (distance) of the contact points Q where the legs 61 come into contact with the ground from the fixed part 60 where the legs 61 are fixed is the greatest and the rigidity of the legs 61 is lowest when the miniature aircraft 1 is in its highest state, and, conversely, the length (distance) of the contact points from the fixed parts 60 where the legs 61 are fixed is the smallest and the rigidity of the legs 61 is highest when the miniature aircraft 1 is in its lowest state.

When the miniature aircraft 1 lands, for example, the rigidity of the legs 61 thereby increases as a load is applied to the legs 61, and collisions between the bottom parts of the fuselage of the miniature aircraft 1 (the spindle element 14 and the like) and the ground can be prevented when the aircraft makes abrupt landings.

An operating unit (controller) (not shown) is provided on the ground (floor) for such a miniature aircraft 1, wireless communication is enabled between the operating unit and the miniature aircraft 1, and the miniature aircraft 1 can be radio-controlled wirelessly from the operating unit (the rotational frequency of the rotors 3 and 5 can be adjusted, and the position of the spindle element 14 in the direction of the x-axis and y-axis can be adjusted).

In this miniature aircraft 1, the rotational frequencies (rotational speeds) of the rotors 3 and 5 are controlled based on the value detected by the gyro sensor 81z in the θz direction, the indicated value (indicated height value) in the direction of the z-axis, and the indicated value (indicated value in the θz direction) around the Z-axis.

Specifically, when the indicated value in the direction of the z-axis is inputted to the θz control circuit 92z, the driving of the vibrating members 4 for rotatably driving the rotors 3 and 5 is controlled via the first drive circuit 931 and the second drive circuit 932 so as to maintain the indicated value (height) in the direction of the z-axis. The miniature aircraft 1 can thereby be raised or lowered in altitude, and a specific height can be maintained.

Also, when the indicated value in the θz direction is inputted to the θz control circuit 92z, the driving of the vibrating members 4 for rotatably driving the rotors 3 and 5 is controlled via the first drive circuit 931 and the second drive circuit 932 so as to maintain the indicated value (orientation) in the θz direction. The miniature aircraft 1 can thereby be rotated by a specific amount (specific angle) forwards or backwards in the θz direction, and can be maintained at a specific angle (orientation) in the θz direction.

Also, in this miniature aircraft 1, the position of the spindle element 14 in the direction of the x-axis is controlled based on the indicated value in the direction of the x-axis and the value of acceleration α in the x-direction detected by the acceleration sensor 81x.

Specifically, when the indicated value in the direction of the x-axis is inputted to the x-direction control circuit 92x, the driving of the vibrating member 4 of the linear actuator 16x is controlled via the x-drive circuit 93x so as to reach the indicated value in the direction of the x-axis. Thereby, the spindle element 14 and the linear actuator 16y are moved in the direction of the x-axis along with the base 161, the center of gravity of the miniature aircraft 1 moves in the direction of the x-axis, and the rotational centerlines 36 of the rotors 3 and 5 of the miniature aircraft 1 rotate by a specific angle in the XZ plane and are inclined by a specific angle in relation to the vertical line with respect to the x-axis.

Thus, the miniature aircraft 1 can be moved (flown) horizontally, for example, in the direction of slanting of the rotational centerline 36.

Also, in this miniature aircraft 1, the position of the spindle element 14 in the direction of the y-axis is controlled based on the value of acceleration α in the y-direction detected by the acceleration sensor 81y, and the indicated value in the direction of the y-axis.

Specifically, when the indicated value in the direction of the y-axis is inputted to the y-direction control circuit 92y, the driving of the vibrating member 4 of the linear actuator 16y is controlled via the y-drive circuit 93y so as to maintain the indicated value in the direction of the y-axis. Thereby, the spindle element 14 moves in the direction of the y-axis, the center of gravity of the miniature aircraft 1 moves in the direction of the y-axis, and the rotational centerlines 36 of the rotors 3 and 5 of the miniature aircraft 1 rotate by a specific angle in the YZ plane and are inclined by a specific angle in relation to a vertical line and in relation to the y-axis.

Thus, the miniature aircraft 1 can be moved (flown) horizontally, for example, in the direction of slanting of the rotational centerline.

As described above, according to this miniature aircraft 1, stable soaring (flying) can be performed, and the miniature aircraft can be moved (flown) to arbitrary positions in an easy and reliable manner.

Particularly, the orientation usually tends to become unstable near the surface of the ground because disturbance increases due to the influence of the ground effects, but this miniature aircraft 1 can take off and land in an easy and reliable manner.

Also, this miniature aircraft 1 has a simple structure that can be made smaller and lighter. Manufacturing costs can also be reduced.

As shown in FIG. 1 (in the reference orientation), in the miniature aircraft 1, the rotary wings 34 and 54 (rotors 3 and 5), the x-axis direction movement device 16x and y-axis direction movement device 16y, the circuit board 13, and the storage battery 15 are disposed in sequence vertically downward. The center of gravity of the miniature aircraft 1 can thereby be lowered, and therefore the miniature aircraft 1 can be flown in a stable manner, and the direction in which the miniature aircraft 1 is flown can be easily changed.

Also, since the storage battery 15 disposed on the lower side is heavy, collisions with the ground can be prevented or softened even if the miniature aircraft 1 touches down on the side of the storage battery 15.

Also, the length of the cable for connecting the circuit board 13 and the storage battery 15 can be reduced because the circuit board 13 and the storage battery 15 are disposed adjacent to each other. The weight of the cable can thereby be reduced, and decreases in voltage can be prevented or suppressed.

Also, since the x-axis direction movement device 16x and y-axis direction movement device 16y, and the circuit board 13 are disposed adjacent to each other, the length of the cable for connecting these components can be reduced. The weight of this cable can thereby be reduced, and decreases in voltage are prevented or suppressed.

Also, the rotary wings 34 and 54 and the x-axis direction movement device 16x and y-axis direction movement device 16y are provided so as to be symmetrical in the longitudinal direction of the center axle 22, as shown in FIG. 20.

The airflow from the rotary wings 34 and 54 can thereby be entirely made to move vertically, and the stability of the airborne miniature aircraft 1 in the vertical direction can therefore be improved.

Also in the present embodiment, one vibrating member 4 each is provided for rotatably driving the driven members 33 and 53, but the present invention also allows a plurality of vibrating members 4 to be provided, and the driven members 33 and 53 may each be rotatably driven by a plurality of vibrating members 4.

In the present embodiment, one spindle element 14 is used, but the present invention also allows a plurality of spindle elements 14 to be provided.

Also in the present invention, the configuration may be designed, for example, so that two spindle elements 14 are provided, one spindle element 14 is moved (displaced) in the direction of the x-axis by the linear actuator 16x, and the other spindle element 14 is moved (displaced) in the direction of the y-axis by the linear actuator 16y. Specifically, the configuration may be designed so that the linear actuator 16x and the linear actuator 16y are separate, each is provided with its own spindle element 14, one spindle element 14 is moved in the direction of the x-axis by the linear actuator 16x, and the other spindle element 14 is moved in the direction of the y-axis by the linear actuator 16y.

Also in the present invention, the method for remote-controlling the miniature aircraft 1 is not limited to radio control, and may use wire control, for example. Specifically, the control unit (not shown) and the miniature aircraft 1 may be controlled by a lead wire (conducting wire) (not shown), and the miniature aircraft 1 may be remote-controlled from the control unit through this lead wire.

Also, the battery is not limited to a storage battery (secondary battery), and may, for example, be a primary battery, a solar battery (a combination of an optoelectric conversion element and a secondary battery), or the like.

### Second Embodiment

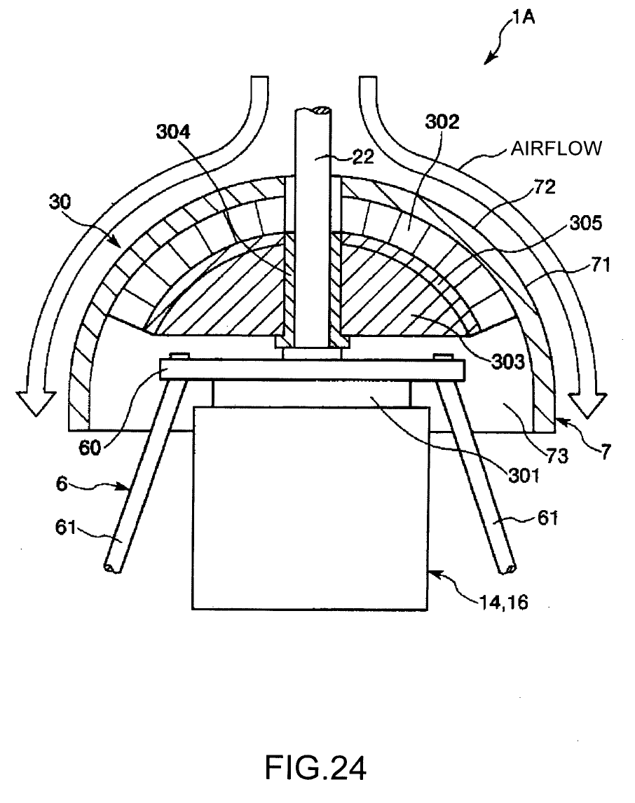

FIG. 24 is a cross-sectional view showing the second embodiment of the miniature aircraft of the present invention.

Hereinbelow, the second embodiment of the miniature aircraft of the present invention is described with reference to the diagrams. The description focuses on the differences with the embodiment previously described, and descriptions of similar aspects are omitted.

The present embodiment is similar to the first embodiment except that the configuration of the energy storage device is different.

In the miniature aircraft 1A, the energy storage device is configured from a fuel cell 30.

As shown in FIG. 24, the fuel cell 30 has a fuel tank 301, a Seebeck element 302 (for example, see Japanese Laid-Open Patent Application No. 2004-140048), and a heat generating unit 303.

The fuel tank 301 is a unit for accommodating (storing) butane or another such fuel, for example. The fuel tank 301 is placed (fixed) on the underside of the fixed part 60.

The heat generating unit 303 is a unit for burning fuel delivered (taken out) from the fuel tank 301. The heat generating unit 303 is in the shape of a dome that follows the shape of the cavity 73 in the cowling 7. This heat generating unit 303 is linked (fixed) to the center axle 22 via a linking member 304 provided to the center axle 22 near the fixed part 60.

The heat generating unit 303 is not particularly limited, but a micro combustor or the like may be used, for example.

The Seebeck element 302 is disposed in a uniform thickness on the outer periphery 305 of the heat generating unit 303. Also, the cowling 7 is provided to the outer periphery (outer side) of the Seebeck element 302, and the cowling 7 functions as a casing for the fuel cell 30 (see FIG. 24). The fuel cell 30 thereby does not need to be provided with a separate casing. Specifically, the number of components constituting the fuel cell 30 can be reduced.

Also, using the fuel cell 30 as the energy storage device makes it possible to increase the time that the miniature aircraft 1 can remain airborne and to make this time greater than when a primary battery or secondary battery (storage battery) is used for the energy storage device.

Next, the process by which electric power (electricity) is generated by the fuel cell 30 with this configuration will be described.

First, fuel is delivered from the fuel tank 301, and the delivered fuel is burned by the heat generating unit 303. A combustion reaction thereby occurs and heat is generated in the outer periphery 305 of the heat generating unit 303.

The heat generated in the outer periphery 305 passes through the Seebeck element 302 and is emitted into the atmosphere. At this time, part of the heat in the Seebeck element 302 is converted to electricity. This electricity is captured and used to drive the miniature aircraft 1.

The cowling 7 is not limited to acting as the casing of the fuel cell 30, and may, for example, be a radiation unit, cooling unit, or a low-temperature heat exchange foundation for the fuel cell 30. The number of components constituting the fuel cell 30 can thereby be reduced. Also, with another type of fuel cell, the cowling may be an ion exchange membrane (for example, an ion exchange membrane of a fuel cell used direct-methanol having a high polymer of an elecrolyte), whereby the supply of air or discharge of exhaust gas or the like may be simplified and performance improved.

### Third Embodiment

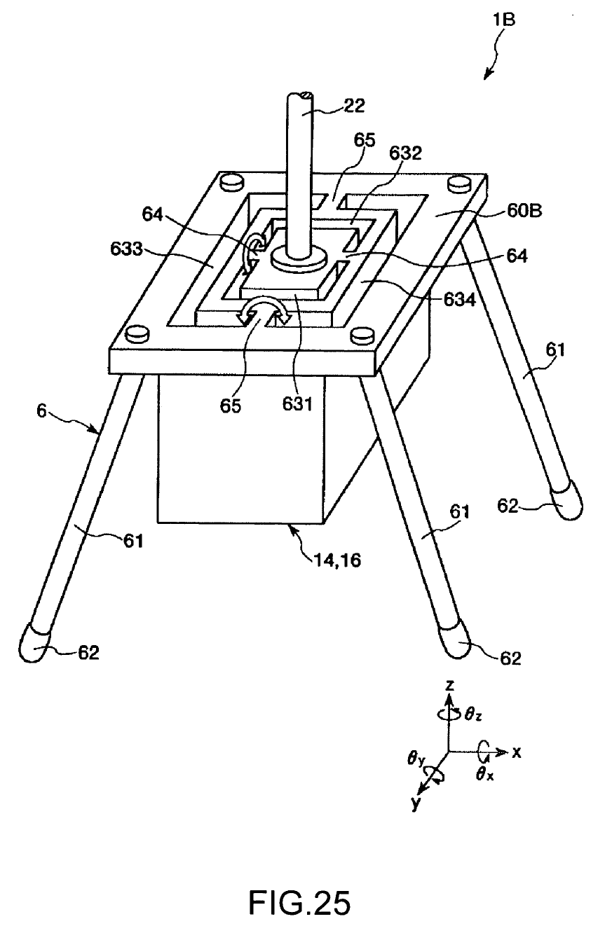

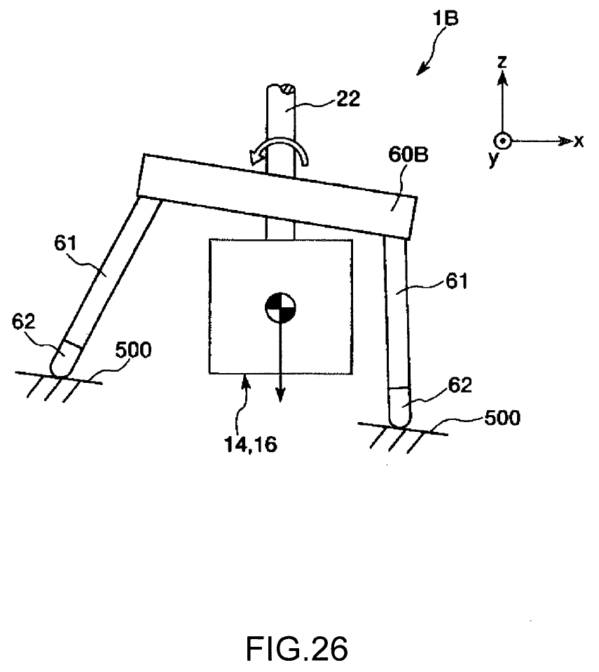

FIG. 25 is a perspective view showing the third embodiment of the miniature aircraft of the present invention, and FIG. 26 is a front view depicting a condition in which the miniature aircraft shown in FIG. 25 is grounded.

Hereinbelow, the third embodiment of the miniature aircraft of the present invention is described with reference to the diagrams. The description focuses on the differences with the embodiments previously described, and descriptions of similar aspects are omitted.

The present embodiment is similar to the first embodiment except that the shape of the fixed part of the grounding device is different.

As shown in FIG. 25, the fixed part 60B of the miniature aircraft 1B is configured from a plate in the shape of a square.

U-shaped grooves 631, 632, 633, and 634 that run through the fixed part 60B in the thickness direction (z-axis direction) are provided to (formed in) the fixed part 60B.

The groove 631 and groove 632 are disposed facing each other about the center axle 22. A thin part 64 is thereby formed between the groove 631 and the groove 632.

Also, the groove 633 and the groove 634 disposed facing each other are formed in the outer sides of the groove 631 and the groove 632 about the center axle 22. A thin part 65 is thereby formed between the groove 633 and the groove 634.

Also, the direction in which the grooves 633 and 634 are formed is at a substantial right angle to the direction in which the grooves 631 and 632 are formed.

As a result of providing such grooves 631, 632, 633, and 634, the thin part 64 easily rotates in the θx direction, and the thin part 65 easily rotates in the θy direction. Specifically, the fixed part 60A has a gimbal structure as a result of the presence of the grooves 631, 632, 633, and 634. The center axle 22 can thereby be inclined in either the θx direction or the θy direction.

As shown in FIG. 26, when the grounding locations 500 are inclined in relation to the horizontal direction, the spindle element 14 receives the vertically downward (in the direction of the z-axis) weight (shown by the arrow in FIG. 26) when the legs 61 (grounding device 6) are grounded at the grounding locations 500. The center axle 22 accordingly receives the vertically downward weight. At this time, the center axle 22 is oriented vertically because it is fixed to the fixed part 60B with the gimbal structure previously described.

Thus, as a result of the center axle 22 being oriented vertically when the miniature aircraft 1B has landed (grounded), the miniature aircraft 1 can easily take off because the thrust during takeoff is oriented vertically upward.

The miniature aircraft of the present invention was described above with reference to the illustrated embodiments, but the present invention is not limited thereto, and the configurations of the components can be replaced with arbitrary configurations having similar functions. Other arbitrary configurations may be appended to the present invention.

The present invention may have a combination of two or more arbitrary configurations (characteristics) from the previous embodiments.

Also, the fixed part of the grounding device with the gimbal structure shown in the second embodiment may be applied as a fixed part for the grounding device of the first embodiment or the fixed part for the grounding device of the second embodiment.

The drive source for rotatably driving the rotors is not limited to the illustrated vibrating members, and may, for example, be an electromagnetic motor, a gas turbine, a reciprocating engine, or the like.

Also in the present invention, the shape and structure of the vibrating members are not limited to the illustrated configurations, and any configuration may be used as long as the driven members can be rotatably driven. For example, one with one piezoelectric element, one with no reinforcing plate, or one with a shape whose width gradually decreases towards the part in contact with the driven member may be used.

The size of the miniature aircraft of the present invention is not particularly limited, but a miniature aircraft wherein a rotor with rotary wings has a relatively small diameter of about 5 to 300 mm is particularly suitable.

Also, in the present invention, the number of legs in the grounding device is not limited to four, and may, for example, be three or five or more.

The number of pawls formed to support the storage battery is not limited to four and may, for example, be two, three, or five or more.

Also, the miniature aircraft of the present invention has the characteristics of being small, lightweight, and highly functional as previously described, and therefore has a broad range of application, and can be applied to toys as well as other various applications. For example, the aircraft can be flown into environments that people cannot enter (narrow locations, radioactive locations, and the like), and can be used as a device for gathering information by means of various sensors, or for transportation.

The terms “front,” “back, “up,” “down,” “perpendicular,” “horizontal,” “slanted,” and other direction-related terms used above indicate the directions in the employed diagrams. Therefore, the direction-related terms used to describe the present invention should be interpreted in relative terms as applied to the employed diagrams.

“Substantially,” “essentially,” “about,” and other terms used above that represent an approximation indicate a reasonable amount of deviation that does not bring about a considerable change as a result. Terms that represent these approximations should be interpreted so as to include an error of about ±5% at least, as long as there is no considerable change due to the deviation.

This specification claims priority to Japanese Patent Application Nos. 2003-18806, 2003-22166, and 2003-22165. All the disclosures in Japanese Patent Application Nos. 2003-18806, 2003-22166, and 2003-22165 are incorporated herein by reference.

Only some embodiments of the present invention are cited in the above description, but it is apparent to those skilled in the art that it is possible to add modifications to the above-described embodiments by using the above-described disclosure without exceeding the range of the present invention as defined in the claims. The above-described embodiments furthermore do not limit the range of the present invention, which is defined by the accompanying claims or equivalents thereof, and are designed to provide solely a description of the present invention.

### KEY TO SYMBOLS

1, 1A, 1B: miniature aircraft, 2: base part, 21: base plate, 212: hole, 22: center axis, 221: hollow part, 222: hole, 23: vibrating member mounting unit, 3: rotor, 31: cylindrical member, 32: rotary wing fixing member, 321: cylindrical part, 322: fixing part, 33: driven member, 331: outer peripheral surface, 34: rotary wings, 35: axle hole, 36: rotational centerline, 4: vibrating member, 41, 45: electrodes, 41a-41d: electrodes, 45a-45d: electrodes, 42, 44: piezoelectric elements, 43: reinforcing plate, 46: convexity, 471, 472: cables, 48: arm, 481: hole, 49: centerline, 5: rotor, 51: cylindrical member, 52: rotary wing fixing member, 521: cylindrical part, 522: fixing part, 523: axle, 53: driven member, 531: outer peripheral surface, 54: rotary wings, 541: axle, 55: axle hole, 6: grounding device, 60, 60A, 60B: fixed part, 61: leg, 62: distal end part, 621: distal end, 631, 632, 633, 634: groove, 64, 65: thin part, 8: orientation control sensor, 81x, 81y: acceleration sensors, 81z: gyro sensor, 7: cowling, 71: outer surface, 72: convexity, 73: cavity, 9: drive control circuit, 91x: αx detection circuit, 91y: ay detection circuit, 91z: θz detection circuit, 92x: x-direction control circuit, 92y: y-direction control circuit, 92z: θz control circuit, 931: first drive circuit, 932: second drive circuit, 93x: x-drive circuit, 93y: y-drive circuit, 11: bearing, 12: bolt, 13: circuit board, 14: spindle element, 141: holding frame, 142: hollow part, 143: side surface, 144: bottom surface, 145: pawl, 15: storage battery, 151: edge, 152: cable, 16: orientation varying device, 16x: x-axis direction movement device, 16y: y-axis direction movement device, 161: base, 162: guide pin, 163: rotor, 1631: groove, 164: rotor, 165: driven member, 1651: outer peripheral surface, 166: cylindrical part, 167: pinion gear, 168: spring stopping pin, 1691, 1692: circular plate part, 171: base stand, 172: long hole, 173: spring holder, 174: coil spring, 175: bolt, 181: slider, 182: opening, 183: rack gear, 184: protrusion, 185: hole, 186: pin, 186a: pin main body, 186b: flange, 186c: hole, 187: first slider part, 188: second slider part, 189: linking part, 19: orientation stabilizer, 191: stabilizer bar, 192: spindle, 193: stabilizer joint, 194: support unit, 195: axle, 200: electrode, 201: power supply, 30: fuel cell, 301: fuel tank, 302: Seebeck element, 303: heat generating unit, 304: linking member, 305: outer periphery, 500: grounding location

What is claimed is:

1. A miniature aircraft, comprising:
an axle having a hollow in said axle along a longitudinal direction thereof;
a first rotary wing being disposed substantially coaxially with said axle;
a second rotary wing being disposed substantially coaxially with said axle and being capable of rotating in an opposite direction of said first rotary wing;
a first drive source being connected to said first rotary wing to rotate said first rotary wing;
a second drive source being connected to said second rotary wing to rotate said second rotary wing; and
cables being inserted in to said hollow and being connected to said first and second drive sources.

2. The miniature aircraft according to claim 1, wherein
said first drive source has a reinforcing plate, piezoelectric elements disposed on both sides of said reinforcing plate, electrodes disposed on said piezoelectric elements, and a convexity integrally disposed on said reinforcing plate and contacting to said first rotor.

3. The miniature aircraft according to claim 1, further comprising
a base part being disposed on said axle, said base part including a mounting unit, wherein
said first drive source includes an arm configured and arranged to fix said first drive source to said mounting unit.

4. The miniature aircraft according to claim 1, further comprising
a cowling being symmetric with respect to said axle, extending away from said second rotary wing as said cowling extends away from said axle.

5. The miniature aircraft according to claim 4, further comprising
an energy reserve unit being connected to said cables that is configured and arranged to provide energy to said first and second drive sources.

6. The miniature aircraft according to claim 5, wherein
said energy reserve unit is a fuel cell.

7. The miniature aircraft according to claim 6, wherein
at least a part of said cowling covers said energy reserve unit.

8. The miniature aircraft according to claim 4, wherein
said cowling includes at least one of a metallic material, resin material, and a combination metallic/resin material.

9. The miniature aircraft according to claim 1, further comprising
a stabilizer including,
a support member being rotatablly disposed on said axle,
a stabilizer bar being swingably disposed on said support member and perpendicularly disposed relative to a rotation center line of said second rotary wing,
spindles being disposed on both ends of said stabilizer bar, and
a stabilizer joint connecting said stabilizer bar and said second rotary wing.

10. The miniature aircraft according to claim 1, further comprising,
a rod shaped leg to land said miniature aircraft,
a connector to connect said leg to said axle.

11. The miniature aircraft according to claim 10, wherein
said connector has a Gimbal structure configured and arranged to vertically sustain said axle.

12. The miniature aircraft according to claim 10, further comprising
an energy reserve unit including a battery to reserve energy and being electrically connected to said cables, wherein
said leg includes an electrode on an end of said leg to contact a power supply when said miniature aircraft lands.

13. The miniature aircraft according to claim 10, wherein
said leg has elasticity that supports said aircraft when said aircraft is taking off.

14. The miniature aircraft according to claim 10, further comprising
an energy reserve unit having a battery and a nail to detachably hold said battery.

15. The miniature aircraft according to claim 1, further comprising
a spindle being disposed on said axle; and
an orientation changer moving said spindle.

16. The miniature aircraft according to claim 15, wherein
said orientation changer includes
a first linear actuator connected to said spindle to move said spindle in a first direction perpendicular to said axle, and
a second linear actuator connected to said spindle to move said spindle in a second direction perpendicular to both said axle and said first direction.

17. The miniature aircraft according to claim 16, wherein
said first linear actuator includes a third drive source, a third rotor having a first pinion gear and a first periphery that contacts to said third drive source, and a first slider being connected to said spindle and having a first rack gear that engages with said first pinion gear, and
said second linear actuator includes a fourth drive source, a fourth rotor having a second pinion gear and a second periphery that contacts to said fourth drive source, and a second slider being connected to said spindle and having a second rack gear that engages with said second pinion gear.

18. The miniature aircraft according to claim 17, wherein
said third drive source has a reinforcing plate, piezoelectric elements that are disposed on both sides of said reinforcing plate, an electrode that is disposed on said piezoelectric elements, and a convexity that contacts to said first rotary wing.

19. The miniature aircraft according to claim 16, further comprising,
an orientation control sensor having a gyro sensor to detect rotation around an axis in a vertical direction, a first acceleration sensor to detect acceleration in said first direction, a second acceleration sensor to detect acceleration in said second direction; and
a drive control circuit controlling said first and second linear actuator based on a direction order from said orientation control sensor.

20. The miniature aircraft according to claim 16, wherein
said first rotary wing and said orientation changer are disposed symmetric with respect to said axle.
